(19) United States
(12) Patent Application Publication
(10) Pub. No.: US 2024/0365789 A1
(43) Pub. Date: Nov. 7, 2024

(54) NOVEL PESTICIDAL COMPOSITION COMPRISING ELEMENTAL SULPHUR AND ACYNONAPYR

(71) Applicants: Hiteshkumar Anilkant DOSHI, Thane (IN); Rajiv RATHOD, Vadodara (IN)

(72) Inventors: Hiteshkumar Anilkant DOSHI, Thane (IN); Rajiv RATHOD, Vadodara (IN)

(21) Appl. No.: 18/689,375

(22) PCT Filed: Sep. 9, 2022
(86) PCT No.: PCT/IB2022/058494

§ 371 Date: Mar. 5, 2024

(30) Foreign Application Priority Data
Sep. 9, 2021 (IN) 202121040937

(51) Int. Cl. A01N 59/02; A01N 25/12; A01N 25/14; A01N 43/42; A01P 7/02

(52) U.S. Cl. CPC A01N 59/02; A01N 25/12; A01N 25/14; A01N 43/42; A01P 7/02

(57) ABSTRACT

The present invention relates to a pesticidal composition comprising Elemental Sulphur, Acynonapyr, and at least one agrochemically acceptable excipient. The invention particularly relates to a pesticidal composition comprising Elemental Sulphur in the range of 20% w/w to 90% w/w of the total composition, Acynonapyr present in the range of 0.1% to 50% w/w of the total composition and at least one agrochemically acceptable excipient. The composition comprises particles in the size range of 0.1 micron to 50 microns. The present invention also relates to process of preparation of the pesticidal composition. The invention relates to a method of treating a plant, crop, plant propagation material, locus or parts thereof, a seed, seedling or surrounding soil with a pesticidal composition.

### 1. FIELD OF THE INVENTION

The present invention relates to a novel pesticidal composition comprising Elemental Sulphur, Acynonapyr and at least one agrochemically acceptable excipient. The present invention relates to a pesticidal composition comprising Elemental Sulphur present in the range of 20% w/w to 90% w/w of the total composition and Acynonapyr present in the range of 0.1% w/w to 50% w/w of the total composition and at least one agrochemically acceptable excipient. The pesticidal composition is in the form of a liquid such as suspension concentrate or liquid suspension, suspoemulsion or a ZC composition (combination of capsulated suspension and suspension concentrate) or in the form of a solid such as wettable powder, water dispersible granule, water disintegrable granule and water dispersible granule of capsulated suspension. Further, the pesticidal composition comprises particles in the size range of from 0.1 micron to 50 microns.

The invention further relates to a process of preparing the pesticidal composition comprising Elemental Sulphur present in the range of 20% w/w to 90% w/w of the total composition and Acynonapyr present in the range of 0.1% w/w to 50% w/w of the total composition and at least one agrochemically acceptable excipient.

The invention furthermore relates to a method of treating plants, crops, plant propagation materials, locus or parts thereof, seeds, seedlings or surrounding soil with the pesticidal composition comprising Elemental Sulphur, Acynonapyr and at least one agrochemically acceptable excipient.

### 2. BACKGROUND OF THE INVENTION

In describing the embodiment of the invention, specific terminology is chosen for the sake of clarity. However, it is not intended that the invention be limited to the specific terms so selected and it is to be understood that each specific term include all technical equivalents that operate in a similar manner to accomplish a similar purpose.

Insect pests including mites are agricultural pests that are responsible for producing damage to growing crops by chewing the leaves of crop plants, sucking out plant juices, boring within the fruits, roots, stems or leaves and also spreading the plant pathogens. The injury done to the plants can be direct or indirect, direct injury in which a feeding insect eats leaves or burrows in stems, fruit or roots. The second type is an indirect damage in which the insect itself does little or no harm but transmits a bacterial, viral, or fungal infection into the crop.

Current pesticidal efficacy of known compounds is not satisfactory in the area of insect pests and acari such as ticks, mite control. On account of diverse practices in different regions, pesticides at times, are administered at relatively higher dosages and it is commonly observed that repeated and prolonged application of individual pesticides or known chemistries at higher dosages eventually result in developing resistance among the pests against such known chemistries. Further, the runoff or leaching associated with the application of pesticidal compositions which are mostly applied in higher dosages to overcome resistance issues, leads to their seepage into the groundwater which leads to soil toxicity and negatively impacts the environment. Again presently, the planting area of economic crops is gradually expanding and with the degree of disease occurrence and increase in the number of pests it is becoming more and more difficult to effectively control these pests.

The current pesticidal combinations are old chemistries and repeated use of such chemical combinations have caused the problems in the control of insect or mite pest population management like resistance of the mites, ticks or insect pests to the pesticide, pest resurgence, secondary pest outbreak, residue related problems, toxic effect on human beings along with the reduced yield, besides higher economic cost.

Moreover, insect species such as aphids, thrips, beetles, whiteflies etc as well as mites are known to be among the most destructive pests in the world, sucking out necessary nutrients, transmitting plant pathogenic viruses/bacteria and causing feeding damage on numerous annual and perennial crops. Such pests are not easily controlled, so there is a need for corrective treatments to keep them under economic damage. Some sucking pest species have developed resistance to virtually all chemical classes of insecticides introduced to control them.

Hence, it is desirable to reduce the rate of application of the pesticidal active ingredients in order to address the adverse environmental or toxicological effects observed with the higher dosages of application of the pesticidal compositions, while also overcoming the issues of development of pest resistance and other drawbacks associated with known chemistries. There also exists a need of newer pesticides with modern integrated pest management for an improved toxicological and environmental profile such as reduced phytotoxicity, resistance management, reduced dosage, substantial broadening of spectrum and increased safety to end users.

Acynonapyr, newly developed acaricide and insecticide with cyclic amine is used to selectively control spider mites. Acynonapyr has an effect on spider mites of Tetranychus and Panonychus and also is effectively used for the control of several pest species. Acynonapyr acts on inhibitory glutamate receptors and disrupts neurotransmission.

Further, the role and benefits of sulphur as a pesticide has been known for a long time. The benefits of sulphur not only encompass reduced dependency on use of chemicals as an effective mode of pest control but being organic in nature it is also environment friendly, increases crop yield, improves food safety, human, animal or plant health and quality of life. The use of sulphur as a fungicide, acaricide and miticide is of special importance and has been long used as an environment friendly mode of farming practice.

There also exist a need for newer pesticides with modem integrated pest management for an improved toxicological and environmental profile such as reduced phytotoxicity, resistance management, reduced dosage, substantial broadening of spectrum, improved synergy and increased safety to humans along with reduced toxicity to the environment to name a few.

Acaricidal composition comprising Acynonapyr are known in the art but there is no specific disclosure of a combination comprising Acynonapyr and Elemental Sulphur.

WO2011105506 relates to Acynonapyr having acaricidal activity. It states that the pesticidal actives that can be present in the composition are either fungicides, other insecticides/acaricides, nematicides, soil insecticides, plant regulators etc and provides a laundry list of pesticidal actives. The application is silent on efficacy and the synergy of specific combination of Elemental sulphur and Acynonapyr in a pesticidal effective amount.

Thus, no specific pesticidal composition comprising Elemental Sulphur and Acynonapyr known or available which can be effectively used with broad spectrum pesticidal activity at lower dosage and address the drawback discussed above with the known compositions.

The inventors of the present invention have developed a stable composition which includes effective amount of Elemental Sulphur and effective amounts of Acynonapyr and at least one agrochemically acceptable excipient, whereby the composition was surprisingly found to be synergistic in nature exhibiting excellent field efficacy. The inventors have found that a composition comprising Elemental Sulphur and Acynonapyr was not only effective in controlling mites but also acts as a superior crop-protectant against other pests, non-phytotoxic, effective at reduced dosages of application, helps in the resistance management observed with the old pesticide chemistry and also demonstrates increased yield on field application

In addition, the inventors surprisingly determined that the composition comprising Elemental Sulphur and Acynonapyr in an effective amount provides excellent pest control and improves yield when the particles in the composition are present in the size range of 0.1 micron to 50 microns.

The inventors found that the composition of the present invention in various formulation types provides organic, ecologically efficient combination of Elemental Sulphur and Acynonapyr in an effective amount which helps to minimize the loss of actives and provides a stable, user friendly formulation. The pesticidal composition with a particle size in the range of 0.1 micron to 50 microns also enhances the physical nature of the formulation by providing improved suspensibility, dispersibility, viscosity, instant dispersion of actives on application via soil or foliar route resulting in an effective control of target insect pest. The compositions of the present invention also demonstrated superior performance under accelerated storage and also surprisingly effective in drip irrigation.

Thus, the inventors of the present invention have developed a stable pesticidal composition comprising Elemental Sulphur in the range of 20% w/w to 90% w/w of the total composition, Acynonapyr in the range of 0.1% w/w to 50% w/w of the total composition, and at least one agrochemically acceptable excipient, wherein particles are present in the size range of 0.1 micron to 50 micron. The pesticidal composition is synergistic in nature and provides crop protection and a nutritional agent at a reduced dosage. The pesticidal composition of the present invention provides a superior composition which is otherwise difficult to achieve in a cost-effective manner. The solid composition of the present invention has granule size in the range of from 0.1 mm to 6 mm and depending upon the formulation type either disintegrates or disperses into particles having size range of 0.1 micron to 50 microns.

### 3. SUMMARY OF THE INVENTION

The invention relates to a novel pesticidal composition comprising Elemental Sulphur and Acynonapyr. The invention relates to a pesticidal composition comprising Elemental Sulphur in the range of 20% w/w to 90% w/w of the total composition and Acynonapyr present in the range of 0.1% w/w to 50% w/w of the total composition and at least one agrochemically acceptable excipient.

Further, the pesticidal composition is in the form of wettable powder, water dispersible granule or extruded granule, broadcast granule or water disintegrable granule or spheronised granule, water dispersible granule of capsulated suspension, liquid suspension or suspension concentrate, suspoemulsion, combination of capsulated suspension and suspension concentrate, flowable concentrate.

The invention also relates to a process for preparing the pesticidal composition comprising Elemental Sulphur in the range of 20% w/w to 90% w/w of the total composition, Acynonapyr in the range of 0.1% w/w to 50% w/w of the total composition and at least one agrochemically acceptable excipient.

According to another embodiment, the invention also relates to a method for protection of crop or improving its health or yield, by treating at least one of a plant, crop, or parts thereof, a plant propagation material, seed, seedling or surrounding soil with a pesticidal composition.

### 4. DETAILED DESCRIPTION OF THE INVENTION

In describing the embodiment of the invention, specific terminology is chosen for the sake of clarity. However, it is not intended that the invention be limited to the specific terms so selected and it is to be understood that such specific terms include all technical equivalents that operate in a similar manner to accomplish a similar purpose. It is understood that any numerical range recited herein is intended to include all subranges subsumed. Also, unless denoted otherwise percentage of components in a composition are presented as weight percent.

The terms “a” or “an”, as used herein, are defined as one or more than one. The terms “including” and/or “having”, as used herein, are defined as comprising (i.e., open language).

The term “Sulphur” used in the composition refers to elemental sulphur obtained through natural sources or synthetic sources. The term includes allotropes of elemental sulfur such as plastic (amorphous) sulfur, monoclinic sulfur, rhombic sulfur composed of S8 molecules, and other ring molecules such as S7 and S12. The term also comprises sulphur produced through processing and refining of petrochemicals. The term also comprises ‘biosulfur’. The term also comprises elemental Sulphur produced through microbial processes.

A water dispersible granule is defined as a formulation which disperses or dissolves rapidly when added to water to give a fine particle suspension. As described herein, “WG” or “WDG” refer to water dispersible granules. Water-dispersible granules are formulated as small, easily measured granules (an agglomeration of fine particles) by blending and agglomerating a ground solid active ingredient together with surfactants and other formulation ingredients which disperses into finer/primary particles when immersed in water.

According to the invention, the term liquid suspension encompasses “aqueous suspension” or aqueous dispersion” or “suspension concentrates (SC)” or “suspoemulsion (SE)” composition. Liquid suspension can be defined as composition wherein solid particles are dispersed or suspended in a liquid. The liquid as a vehicle can be water and/or a water miscible solvent.

As defined herein, aqueous suspo-emulsion is essentially a mixture of water-insoluble active constituents dispersed in a water-based solution; where one (or more) of the active constituents is a solid, formulated as a suspension form (SC) and one (or more) of the actives is an oil, formulated as an emulsion in water (EW).

As defined herein, WP refers to a wettable powder, which can be a powder formulation to be applied as a suspension after dispersion in water.

As defined herein, GR or Water disintegrable granule refers to a granular composition comprising of agglomerated granules or particles which disintegrates or breaks into individual particles.

As defined herein, ZC formulations are a combination of capsulated suspensions and suspension concentrates such that the formulation contains a stable aqueous suspension of microcapsules and a suspension of solid fine particles (in an aqueous phase), each of which contains at least one active ingredient.

As defined herein, CS or capsulated suspension refers to a formulation which is a combination of an active ingredient encapsulated in polymer shell suspended in water with one or more surfactants, wherein the suspension may include a further active. Water dispersible granules of capsulated suspension relates to a granular composition obtained by spray drying a capsulated suspension composition.

As defined herein, OD refers to oil dispersion or oil suspension wherein a solid active ingredient is dispersed in oil. The oil can vary from paraffinic to aromatic solvent types and vegetable oil or methylated seed oils.

The present invention relates to a pesticidal composition comprising Elemental Sulphur, Acynonapyr and at least one agrochemically acceptable excipient.

The present invention relates to a pesticidal composition comprising Elemental Sulphur in the range of 20% w/w to 90% w/w of the total composition and Acynonapyr present in the range of 0.1% w/w to 50% w/w of the total composition and at least one agrochemical excipient.

The present invention relates to a pesticidal composition comprising Elemental Sulphur in the range of 20% w/w to 90% w/w of the total composition and Acynonapyr present in the range of 0.1% w/w to 50% w/w of the total composition and at least one agrochemical excipient present in the range of 0.1% w/w to 80% w/w of the total composition.

According to an embodiment, Elemental Sulphur is present in the range of 20% w/w to 90% w/w of the total composition. According to an embodiment, Elemental Sulphur is present in the range of 20% w/w to 80% w/w of the total composition. According to an embodiment, Elemental Sulphur is present in the range of 20% w/w to 70% w/w of the total composition. According to an embodiment, Elemental Sulphur is present in the range of 20% w/w to 60% w/w of the total composition. According to an embodiment, Elemental Sulphur is present in the range of 20% w/w to 40% w/w of the total composition.

According to an embodiment, Acynonapyr is present in the range of 0.1% to 50% w/w of the total composition. According to an embodiment, Acynonapyr is present in the range of 0.1% to 40% w/w of the total composition. According to an embodiment, Acynonapyr is present in the range of 0.1% to 30% w/w of the total composition. According to an embodiment, Acynonapyr is present in the range of 0.1% to 20% w/w of the total composition. According to an embodiment, Acynonapyr is present in the range of 0.1% to 15% w/w of the total composition.

According to an embodiment, Acynonapyr is present in the range of 0.1% to 10% w/w of the total composition.

According to an embodiment, the pesticidal composition is in the form of a solid a liquid or a gel or a paste.

According to an embodiment, the liquid pesticidal composition can be in the form of suspension, oil dispersion, liquid suspension, flowable concentrate, seed dressing, suspo-emulsion, combination of capsulated suspension and suspension concentrate (ZC).

According to an embodiment, the liquid pesticidal composition preferably is in the form of liquid suspension or suspension concentrate, suspo-emulsion and a ZC combination which is a combination of a capsulated suspension and suspension concentrate.

According to an embodiment, the liquid pesticidal composition is preferably in the form of a liquid suspension or a suspension concentrate. According to an embodiment, the liquid suspension or a suspension concentrate comprises Elemental Sulphur in a range of 20% w/w to 70% w/w of the total composition and Acynonapyr in the range of 0.1% w/w to 30% w/w of the total composition.

According to an embodiment, the liquid pesticidal composition is preferably in the form of a suspo-emulsion. According to an embodiment, the suspo-emulsion composition comprises Elemental Sulphur in a range of 20% w/w to 70% w/w of the total composition and Acynonapyr in the range of 0.1% w/w to 25% w/w of the total composition.

According to an embodiment, the liquid pesticidal composition is preferably in the form of a ZC composition (combination of capsulated suspension and suspension concentrate).

According to an embodiment, the ZC composition comprises Elemental Sulphur in a range of 20% w/w to 70% w/w of the total composition and Acynonapyr in the range of 1% w/w to 25% w/w of the total composition.

According to an embodiment, the pesticidal composition is in the form of powders including wettable powder, dust and dispersible powder. According to an embodiment, the pesticidal composition is in the form of granules include broadcast granules, pellets, extruded granules, water dispersible granules, water disintegrable granules, dry capsulated suspension or a dry ZC composition (combination of capsulated suspension and suspension concentrate).

According to an embodiment, the pesticidal composition preferably is in the form of wettable powder, water dispersible granules and water disintegrable granules.

According to an embodiment, the wettable powder composition comprises Elemental Sulphur in a range of 20% w/w to 90% w/w of the total composition and Acynonapyr in the range of 0.1% w/w to 50% w/w of the total composition.

According to an embodiment, the pesticidal composition is preferably in the form of water dispersible granules.

According to an embodiment, the water dispersible granular composition comprises Elemental Sulphur in a range of 20% w/w to 90% w/w of the total composition and Acynonapyr in the range of 0.1% w/w to 40% w/w of the total composition.

According to an embodiment, the pesticidal composition is preferably in the form of a water dispersible granules of capsulated suspension.

According to an embodiment, the water dispersible granules of capsulated suspension comprise Elemental sulphur in a range of 20% w/w to 80% w/w of the total composition and Acynonapyr in the range of 0.1% w/w to 30% w/w of the total composition.

According to an embodiment, the pesticidal composition comprises granules in the size range of 0.1 mm to 6 mm. According to an embodiment, the pesticidal composition comprises granules in the size range of 0.1 to 5 mm. According to an embodiment, the pesticidal composition comprises granules in the size range of 0.1 to 4 mm. According to an embodiment, the pesticidal composition comprises granules in the size range of 0.1 to 3 mm. According to an embodiment, the pesticidal composition comprises granules in the size range of 0.1 to 2 mm. According to an embodiment, the pesticidal composition have granule size in the range of 0.1 to 1.5 mm.

According to an embodiment, the pesticidal composition in the form of water disintegrable granules or spheronised granules or extruded granules wherein the granules are in the size range of 0.1 mm to 6 mm. According to an embodiment, the granules are in the size range of 0.1 mm to 5 mm. According to an embodiment, the granules are in the size range of 0.1 mm to 4 mm. According to an embodiment, the granules are in the size range of 0.1 mm to 3.5 mm.

According to an embodiment, the pesticidal composition in the form of water dispersible granules or water dispersible granules of capsulated suspension, where the granules are in the size range of 0.1 mm to 3 mm. According to an embodiment, the pesticidal composition in the form of water dispersible granules, where the granules are in the size range of 0.1 mm to 2.5 mm. According to an embodiment, the pesticidal composition in the form of water dispersible granules, where the granules are in the size range of 0.1 mm to 2.0 mm. According to an embodiment, the pesticidal composition in the form of water dispersible granules, where the granules are in the size range of 0.1 mm to 1.5 mm.

According to an embodiment, the particle size of the pesticidal composition is in the range of 0.1 micron to 50 microns. According to further embodiment, the particle size of the pesticidal composition is in the range of 0.1 micron to 40 microns. According to further embodiment, the particle size of the pesticidal composition is in the range of 0.1 micron to 30 microns. According to further embodiment, the particle size of the pesticidal composition is in the range of 0.1 micron to 20 microns. According to further embodiment, the particle size of the pesticidal composition is in the range of 0.1 micron to 15 microns. According to further embodiment, the particle size of the pesticidal composition is in the range of 0.1 micron to 10 microns. The particle size range of 0.1-50 microns of the pesticidal composition was found to be important not only in terms of ease of application but also in terms of efficacy. The composition of the present invention disperses or disintegrates to particles in the size range of 0.1 micron to 50 microns when comes in contact with water depending on formulation type of the composition.

According to an embodiment, the pesticidal composition in the form of wettable powder, water disintegrable granules or broadcast or spheronised or extruded granules comprise particles in the size range of 0.1 micron to 50 microns.

According to an embodiment, the pesticidal composition in the form of water dispersible granules, water dispersible granules of capsulated suspension, liquid suspensions or suspension concentrates, suspoemulsion or ZC composition comprises particles in the size range of 0.1 micron to 30 microns. According to an embodiment, the pesticidal composition in the form of water dispersible granules, or water dispersible granules of capsulated suspension, liquid suspensions or suspension concentrates, suspoemulsion or ZC composition comprises particles in the size range of 0.1 micron to 20 microns. According to an embodiment, the pesticidal composition in the form of water dispersible granules or water dispersible granules of capsulated suspension, liquid suspensions or suspension concentrates, suspoemulsion or ZC composition comprises particles in the size range of 0.1 micron to 10 microns.

According to an embodiment, the pesticidal composition comprises at least one agrochemically acceptable excipient. According to further embodiment, the agrochemically acceptable excipient comprises at least one of surfactants, binders or binding agents, wetting agent, emulsifiers, disintegrating agents, fillers or carriers or diluents, coating agents, buffers or pH adjusters or neutralizing agents, antifoaming agents or defoamers, penetrants, ultraviolet absorbents, UV ray scattering agents, stabilizers, pigments or colorants, structuring agents, chelating or complexing or sesquitering agent, thickeners, suspending agents or suspension aid agents or anticaking agents or anti-settling agents, viscosity modifiers or rheology modifiers, tackifiers, humectants, sticking agents, anti-freezing agent or freeze point depressants, solvents include water immiscible solvents or water miscible solvents, polymerms, monomers, cross-linking agents, permeability enhancing agents, protective colloids and mixtures thereof. However, those skilled in the art will appreciate that it is possible to utilize additional agrochemically acceptable excipients without departing from the scope of the present invention.

According to an embodiment, the pesticidal composition in the form of water dispersible or spheronised granules or extruded granule or wettable powder or water disintegrable granule further comprises at least one agrochemical excipient which includes disintegrating agent, surfactant, binders or fillers or carriers or diluent, antifoaming agent, anticaking agent or antisettling or suspension aid or suspending agent, penetrating agent, sticking agent, tackifier, pigments, colorants, stabilizers. However, those skilled in the art will appreciate that it is possible to utilize additional agrochemically acceptable excipients without departing from the scope of the present invention.

According to an embodiment, the pesticidal composition in the form of water dispersible granules or wettable powder composition comprises at least one agrochemical excipient which includes dispersing agents, surfactants, wetting agents, binders or fillers or carriers or diluents, antifoaming agents, ultraviolet absorbents, UV ray scattering agents, anticaking agents or antisettling or suspension aid or suspending agents, sticking agents, pigments, colorants, and stabilizers. However, those skilled in the art will appreciate that it is possible to utilize additional agrochemically acceptable excipients without departing from the scope of the present invention.

According to an embodiment, the liquid pesticidal composition in the form of suspension concentrate or liquid suspension or suspoemulsion composition comprises at least one agrochemical excipient which includes dispersing agents, structuring agents, surfactants, humectants, solvents, suspending agents or suspension aid or anticaking agent or antisettling agents, penetrating agents, sticking agents, ultraviolet absorbents, UV ray scattering agents, buffers or pH adjusters or neutralizing agents, stabilizers, emulsifiers, biocides, antifreezing agents or freeze point depressants, and antifoaming agents. However, those skilled in the art will appreciate that it is possible to utilize additional agrochemically acceptable excipients without departing from the scope of the present invention.

According to an embodiment, the ZC composition comprises at least one agrochemical excipient which includes at least one dispersing agents, structuring agents, surfactants, wetting agents, humectants, solvents, suspending agents or suspension aid or anticaking agents or antisettling agents, penetrating agents, sticking agents, ultraviolet absorbents, UV ray scattering agents, buffers or pH adjusters or neutralizing agents, stabilizers, emulsifiers, biocides, antifreezing agents or freeze point depressants, antifoaming agents, monomers such as isocyanates and diamines or glycols, cross-linking agents, polymers, protective colloids and permeability enhancing agents However, those skilled in the art will appreciate that it is possible to utilize additional agrochemically acceptable excipients without departing from the scope of the present invention.

According to an embodiment, the water dispersible granules of capsulated suspension comprise at least one agrochemical excipient which includes dispersing agents, surfactants, wetting agents, suspending agents or suspension aid or anticaking agents or antisettling agents, penetrating agents, sticking agents, ultraviolet absorbents, UV ray scattering agents, buffers or pH adjusters or neutralizing agents, stabilizers, emulsifiers, antifoaming agents, monomers, polymers, cross-linking agents, permeability enhancing agents, protective colloids and stabilizers. However, those skilled in the art will appreciate that it is possible to utilize additional agrochemically acceptable excipients without departing from the scope of the present invention.

According to an embodiment, the agrochemically acceptable excipient is present in the range of from 0.1% w/w to 80% w/w of the total composition. According to an embodiment, the agrochemically acceptable excipient is present in the range of from 0.1% w/w to 70% w/w of the total composition. According to an embodiment, the agrochemically acceptable excipient is present in the range of from 0.1% w/w to 60% w/w of the total composition. According to an embodiment, the agrochemically acceptable excipient is present in the range of from 0.1% w/w to 50% w/w of the total composition. According to an embodiment, the agrochemically acceptable excipient is present in the range of from 0.1% w/w to 40% w/w of the total composition. According to an embodiment, the agrochemically acceptable excipient is present in the range of from 0.1% w/w to 30% w/w of the total composition.

According to an embodiment, the surfactants which are used in the pesticidal composition include one or more of anionic, cationic, non-ionic, amphoteric and polymeric surfactants. According to an embodiment, the surfactants include one or more of emulsifiers, wetting agents and dispersing agents.

The anionic surfactants include one or more of, but not limited to a salt of fatty acid, a benzoate, a polycarboxylate, a salt of alkylsulfuric acid ester, alkyl ether sulfates, an alkyl sulfate, an alkylaryl sulfate, an alkyl diglycol ether sulfate, a salt of alcohol sulfuric acid ester, an alkyl sulfonate, an alkylaryl sulfonate, a lignin sulfonate, an alkyldiphenyletherdisulfonate, a polystyrene sulfonate, a salt of alkylphosphoric acid ester, an alkylaryl phosphate, styrylaryl hydroxyl phosphate or their derivatives, a styrylaryl phosphate, docusates, a salt of polyoxyethylene alkyl ether sulfuric acid ester, a polyoxyethylenealkylaryl ether sulfate, alkyl sarcosinates, alpha olefin sulfonate sodium salt, alkyl benzene sulfonate or its salts, sodium lauroylsarcosinate, sulfosuccinates, polyacrylates, salts of polyacrylates, salt of polyoxyethylenealkylaryl ether sulfuric acid ester, a polyoxyethylene alkyl ether phosphate, a salt of polyoxyethylenealkylaryl phosphoric acid ester, sulfosuccinates-mono and other diesters, phosphate esters, alkyl naphthalene sulfonates such as isopropyl and butyl derivatives, alkyl ether sulfates—sodium and ammonium salts; alkyl aryl ether phosphates, a salt of polyoxyethylene aryl ether phosphoric acid ester, mono-alkyl sulphosuccinates, aromatic hydrocarbon sulphonates, 2-acrylamido-2-methylpropane sulfonic acid, ammonium lauryl sulfate, ammonium perfluorononanoate, Disodium cocoamphodiacetate, Magnesium laureth sulfate, Perfluorobutanesulfonic acid, Perfluorononanoic acid, carboxylates, Perfluorooctanesulfonic acid, Perfluorooctanoic acid, Phospholipid, Potassium lauryl sulfate, Soap, Soap substitute, Sodium alkyl sulfate, Sodium dodecyl sulfate, Sodium dodecylbenzenesulfonate, Sodium laurate, Sodium laureth sulfate, Sodium lauroylsarcosinate, Sodium myreth sulfate, Sodium nonanoyloxybenzenesulfonate, Sodium pareth sulfate, alkyl carboxylates, Sodium stearate, alpha olefin sulphonates, naphthalene sulfonate salts, alkyl naphthalene sulfonate fatty acid salts, naphthalene sulfonate condensates-sodium salt, fluoro carboxylate, fatty alcohol sulphates, alkyl naphthalene sulfonate condensates-sodium salt, a naphthalene sulfonic acid condensed with formaldehyde or a salt of alkylnaphthalene sulfonic acid condensed with formaldehyde; or salts, derivatives thereof.

The non-ionic surfactants include one or more of but not limited to polyol esters, polyol fatty acid esters, polyethoxylated esters, polyethoxylated alcohols, ethoxylated and propoxylated fatty alcohols, ethoxylated and propoxylated alcohols, EO/PO copolymers; EO and PO block copolymers, di, tri-block copolymers; block copolymers of polyethylene glycol and polypropylene glycol, poloxamers, polysorbates, alkyl polysaccharides such as alkyl polyglycosides and blends thereof, amine ethoxylates, sorbitan fatty acid ester, glycol and glycerol esters, glucosidyl alkyl ethers, polyoxyethylene glycol, sorbitan alkyl esters, sorbitan derivatives, fatty acid esters of sorbitan (Spans) and their ethoxylated derivatives (Tweens), and sucrose esters of fatty acids, Cetostearyl alcohol, Cetyl alcohol, Decyl glucoside, Decylpolyglucose, Glycerol monostearate, Lauryl glucoside, Maltosides, Monolaurin, Narrow-range ethoxylate, Nonidet P-40, Nonoxynol-9, Nonoxynols, Octaethylene glycol monododecyl ether, N-Octyl beta-D-thioglucopyranoside, Octyl glucoside, Oleyl alcohol, PEG-10 sunflower glycerides, Pentaethylene glycol monododecyl ether, Polidocanol, Poloxamer, Poloxamer 407, Polyethoxylated tallow amine, Polyglycerol polyricinoleate, Polysorbate, Polysorbate 20, Polysorbate 80, Sorbitan derivatives, Sorbitan monolaurate, Sorbitanmonostearate, Sorbitantristearate, Stearyl alcohol, glyceryl laureate, lauryl glucoside, nonylphenolpolyethoxyethanols, nonyl phenol polyglycol ether, castor oil ethoxylate, polyglycol ethers, polyadducts of ethylene oxide and propylene oxide, block copolymer of polyalkylene glycol ether and hydroxystearic acid, tributylphenoxypolyethoxy ethanol, octylphenoxypolyethoxy ethanol, etho-propoxylatedtristyrlphenols, ethoxylated alcohols, polyoxy ethylene sorbitan, fatty acid polyglyceride, a fatty acid alcohol polyglycol ether, an oxyalkylene block polymer, a polyoxyethylene alkyl ether, a polyoxyethylenealkylaryl ether, a polyoxyethylenestyrylaryl ether, a polyoxyethylene glycol alkyl ether, polyethylene glycol, a polyoxyethylene fatty acid ester, a polyoxyethylenesorbitan fatty acid ester, a polyoxyethylene glycerin fatty acid ester, Alcohol ethoxylates—C6 to C16/18 alcohols, linear and branched, Alcohol alkoxylates—various hydrophobes and EO/PO contents and ratios, Fatty acid esters—mono and diesters; lauric, stearic and oleic; Glycerol esters—with and without EO; lauric, stearic, cocoa and tall oil derived, Ethoxylated glycerine, Sorbitan esters—with and without EO; lauric, stearic and oleic based; mono and triesters, Castor oil ethoxylates—5 to 200 moles EO; non-hydrogenated and hydrogenated, Block polymers, Amine oxides—ethoxylated and non-ethoxylated; alkyl dimethyl, Fatty amine ethoxylates—coco, tallow, stearyl, oleyl amines, a polyoxyethylene hydrogenated castor oil or a polyoxypropylene fatty acid ester; salts or derivatives thereof.

Amphoteric or Zwitterionic surfactants include one or more of, but not limited to one or more of betaine, coco and lauryl amidopropyl betaines, Coco Alkyl Dimethyl Amine Oxides, alkyl dimethyl betaines; C8 to C18, Alkyl dipropionates—sodium lauriminodipropionate, Cocoamidopropylhydroxysulfobetaine, imidazolines, phospholipids phosphatidylserine, phosphatidylethanolamine, phosphatidylcholine, and sphingomyelins, Lauryl Dimethylamine Oxide, alkyl amphoacetates and proprionates, alkyl Ampho(di)acetates, and diproprionates, lecithin and ethanolamine fatty amides or salts, derivatives thereof.

Surfactants that are commercially available under the trademark but are not limited to one or more of Atlas G5000, TERMUL 5429, TERMUL 2510, ECOTERIC®, EULSOGEN® 118, Genapol®X, Genapol®OX-080, Genapol® C 100, Emulsogen® EL 200, Arlacel P135, Hypermer 8261, Hypermer B239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, Cetomacrogol 1000, CHEMONIC OE-20, Triton N-101, Triton X-100, Tween 20, 40, 60, 65, 80, Span20, 40, 60, 80, 83, 85, 120, Brij@, Atlox 4912, Atlas G5000, TERMUL 3512, TERMUL 3015, TERMUL 5429, TERMUL 2510, ECOTERIC®, ECOTERIC® T85, ECOTERIC® T20, TERIC 12A4, EULSOGEN® 118, Genapol®X, Genapol®OX-080, Genapol® C 100, Emulsogen® EL 200, Arlacel P135, Hypermer 8261, Hypermer B239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, CHEMONIC OE-20, Triton™ N-101, IGEPAL CA-630 and Isoceteth-20.

However, those skilled in the art will appreciate that it is possible to utilize other conventionally known surfactants without departing from the scope of the present invention. The surfactants are commercially manufactured and available through various companies.

According to an embodiment, the surfactant is present in an amount of 0.1% to 60% w/w of the total composition. According to an embodiment, the surfactant is present in an amount of 0.1% to 40% w/w of the total composition. According to an embodiment; the surfactant is present in an amount of 0.1% to 30% w/w of the total composition. According to a further embodiment, the surfactant is present in an amount of 0.1% to 20% w/w of the total composition. According to an embodiment, the surfactant is present in an amount of 0.1% to 10% w/w of the total composition.

According to an embodiment, the dispersing agents which are used in the pesticidal composition includes, but not limited to one or more of polyvinyl alcohol, phenol naphthalene sulphonates, lignin sulphonates, lignin derivatives, dibutylnaphthalene-sulfonic acid, alkylarylsulfonates, alkyl sulfates, alkylsulfonates, fatty alcohol sulfates, fatty acids and sulfated fatty alcohol glycol ethers, polyoxyethylene alkyl ethers, dioctyl sulfosuccinate, lauryl sulfate, polyoxyethylenestyryl phenyl ether sulfate ester salts and the like, alkali metal salts thereof, ammonium salts or amine salts, polyoxyethylenestyryl phenyl ether, polyoxyethylenesorbitan alkyl esters, and the like, mixture of sodium salt of naphthalene sulphonic acid urea formaldehyde condensate and sodium salt of phenol sulphonic formaldehyde condensate ethoxylated alkyl phenols, ethoxylated fatty acids, alkoxylated linear alcohols, polyaromatic sulfonates, sodium alkyl aryl sulfonates, glyceryl esters, ammonium salts of maleic anhydride copolymers, phosphate esters, salts of addition products of ethylene oxide and fatty acid esters, polycarboxylates, sodium salts of condensed phenolsulfonic acid as well as the napthalene sulfonate-formaldehyde condensates, sodium naphthalene sulfonate formaldehyde condensates, ammonium salts of sulfonated naphthalene, salts of polyacrylic acids, tristyrylphenolethoxylate phosphate esters, aliphatic alcohol ethoxylates, alkyl ethoxylates, EO-PO block copolymers, graft copolymers, ammonium salts of sulfonated naphthalene, salts of polyacrylic acids, salts, derivatives thereof, Poly methyl methacrylate/Acrylic Graft co-polymer and its derivatives, Nonyl-phenol ethoxylates and its derivatives, Castor oil based ethoxylates, sorbitan ester ethoxylates, Lanolin alcohol ethoxylates, Polyol ethoxylates, Phosphate esters and its derivatives, stearic fatty acids and its derivatives, oleic fatty acids, vegetable fatty acids, tallow fatty acids ethoxylates,

Commercially available dispersing agents include “Morwet D425” (sodium naphthalene formaldehyde condensate ex Nouryon Corporation, USA) “Morwet EFW” Sulfated Alkyl Carboxylate and Alkyl Naphthalene Sulfonate—Sodium Salt “Tamol PP” (sodium salt of a phenolsulphonic acid condensate) “Reax 80N” (sodium lignosulphonate) “Wettol D1” sodium alkylnaphthalene sulphonate (ex BASF). However, those skilled in the art will appreciate that it is possible to utilize other conventionally known dispersants without departing from the scope of the present invention. The dispersing agents are commercially manufactured and available through various companies.

According to an embodiment, the dispersing agent is present in an amount of 0.1-60% w/w of the total composition. According to an embodiment, the dispersing agent is present in an amount of 0.1-30% w/w of the total composition. According to an embodiment, the dispersing agent is present in an amount of 3-20% w/w of the total composition.

According to an embodiment the wetting agents used in the pesticidal composition include, but not limited to one or more of phenol naphthalene sulphonates, alkyl naphthalene sulfonate and their salts, sodium alkyl naphthalene sulfonate, sodium salt of sulfonated alkylcarboxylate, polyoxyalkylated ethyl phenols, polyoxyethoxylated fatty alcohols, polyoxyethoxylated fatty amines, lignin derivatives, alkane sulfonates or their salts, alkylbenzene sulfonates, salts of polycarboxylic acids, salts of esters of sulfosuccinic acid, alkylpolyglycol ether sulfonates, alkyl ether phosphates, alkyl ether sulphates and alkyl sulfosuccinic monoesters, Alkyl polyglucoside, Alkyl polysaccharide, or their salts or derivatives thereof. However, those skilled in the art will appreciate that it is possible to utilize other conventionally known wetting agents without departing from the scope of the present invention. The wetting agents are commercially manufactured and available through various companies.

According to an embodiment, the wetting agent is present in an amount of 0.1%-60% w/w of the total composition. According to an embodiment, the wetting agent is present in an amount of 0.1%-40% w/w of the total composition. According to an embodiment, the wetting agent is present in an amount of 0.1%-30% w/w of the total composition.

According to an embodiment the emulsifiers used in the pesticidal composition include, but not limited to one or more of, alkylated benzene sulphonates, ethoxylated or alkoxylated tristyrylphenols, alkoxylated coplymers, fatty alcohol ethoxylates, fatty acid derivatives, sorbitol derivatives, castor oil ethoxylates and derivatives, ethoxylated phenols, ethoxylated alkylphenols, nonylphenol alkoxylates, alcohol alkoxylates, sulphosuccinates, alkyletherphosphates, alkoxylated fatty alcohol phosphates (e.g. PEG 10 PPG 5 Cetyl phosphate), polyvinyl alcohol, polyvinyl pyrrolidone, lignin sulfonate, poly acrylates, polysorbates, polycarboxylates, alcohol ethoxylates, salt of alkyl aryl sulphonates derivative thereof. However, those skilled in the art will appreciate that it is possible to utilize other conventionally known wetting agents without departing from the scope of the present invention. The emulsifiers are commercially manufactured and available through various companies.

Emulsifiers which are used in the pesticidal composition include but are not limited one or more of Atlas G5000, TERMUL 5429, TERMUL 2510, ECOTERIC®, EMULSOGEN® 118, Genapol®X, Genapol®OX-080, Genapol® C 100, Emulsogen® EL 200, Arlacel P135, Hypermer 8261, Hypermer B239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, CHEMONIC OE-20, Triton™ N-101, Tween 20, 40, 60, 65, 80, Span20, 40, 60, 80, 83, 85, 120, Brij®, Triton™ Atlox 4912, Atlas G5000, TERMUL 3512, TERMUL 3015, TERMUL 5429, TERMUL 2510, ECOTERIC®, ECOTERIC® T85, ECOTERIC® T20, TERIC 12A4, EULSOGEN® 118, Genapol®X, Genapol®OX-080, Genapol® C 100, Emulsogen® EL 200, Arlacel P135, Hypermer 8261, Hypermer B239, Hypermer B261, Hypermer B246sf, Solutol HS 15, Promulgen™ D, Soprophor 7961P, Soprophor TSP/461, Soprophor TSP/724, Croduret 40, Etocas 200, Etocas 29, Rokacet R26, CHEMONIC OE-20, Triton™ N-101, Tween 20, 40, 60, 65, 80 and Span 20, 40, 60, 80, 83, 85, 120 can also be used. However, those skilled in the art will appreciate that it is possible to utilize other conventionally known emulsifiers without departing from the scope of the present invention. The emulsifiers are commercially manufactured and available through various companies.

According to an embodiment, the emulsifier is present in an amount of 0.1%-60% w/w of the total composition. According to an embodiment, the emulsifier is present in an amount of 0.1%-50% w/w of the total composition. According to an embodiment, the emulsifier is present in an amount of 0.1%-30% w/w of the total composition.

According to an embodiment, the solvents used in the pesticidal composition include water miscible solvents or water immiscible solvents.

The water miscible solvents include, but are not limited to Ethylene glycol, Glycerol, N-Methyl-2-pyrrolidone, 1,3-Propanediol, 1,5-Pentanediol, Propylene glycol, Triethylene glycol, 1,2-Butanediol, 1,3-Butanediol, 1,4-Butanediol, Dimethylformamide, Decainamide, Dimethoxyethane, Dimethyloctanamide, Dimethyldecanamide, Water, Propylene glycol, monoethylene glycol, poly ethylene glycol ether and its derivatives, glycerol, Sorbitol, Dimethyloctanamide, Dimethyldecanamide, Dimethyloctadecanamide, Monobutyl ether, in general glycols and glycol ethers, alkylene carbonates, n-methyl pyrrolidone, Dimethylformamide, Acetophenone, Cyclohexanone, dimethyl sulfoxide. However, those skilled in the art will appreciate that it is possible to utilize other water miscible solvents without departing from the scope of the present invention.

According to an embodiment, the solvent is present in an amount of 0.1-80% w/w of the total composition. According to an embodiment, the solvent is present in an amount of 0.1-60% w/w of the total composition. According to an embodiment, the solvent is present in an amount of 0.1-40% w/w of the total composition. According to an embodiment, the solvent is present in an amount of 0.1-30% w/w of the total composition.

According to an embodiment, the disintegrating agents which are used in the pesticidal composition include, but not limited to one or more of inorganic water soluble salts of sodium, potassium, magnesium, ammonium, nitrate, acetate e.g. sodium chloride, potassium chloride, potassium nitrate; water insoluble organic compounds such as microcrystalline cellulose, cross-linked sodium carboxymethyl cellulose, carboxymethyl calcium, cellulose powder; sodium tripolyphosphate, sodium hexametaphosphate, metal stearates, dextrin, methacrylate copolymer, Polyplasdone® XL-10 (crosslinked polyvinylpyrrolidone), polyaminocarboxylic acid, sulfonated styrene-isobutylene-maleic anhydride copolymer, salts of polyacrylates or methacrylates, starch-polyacrylonitrile graft copolymer, sodium or potassium bicarbonates/carbonates or their mixtures or salts with acids such as citric and fumaric acid, or salts, phenol naphthalene sulphonates, alkyl naphthalene sulfonate, sodium alkyl naphthalene sulfonate, sodium salt of sulfonated alkylcarboxylate, polyoxyalkylated ethyl phenols, polyoxyethoxylated fatty alcohols, polyoxyethoxylated fatty amines, lignin derivatives, alkane sulfonates, alkylbenzene sulfonates, salts of polycarboxylic acids, salts of esters of sulfosuccinic acid, alkylpolyglycol ether sulfonates, alkyl ether phosphates, alkyl ether sulphates and alkyl sulfosuccinic monoesters, lignosulphonates, salts derivatives thereof. However, those skilled in the art will appreciate that it is possible to utilize different disintegrating agents without departing from the scope of the present invention. The disintegrating agents are commercially manufactured and available through various companies.

According to an embodiment, the disintegrating agent is present in an amount of 0.1% to 50% w/w of the composition. According to an embodiment, the disintegrating agent is present in an amount of 0.1% to 30% w/w of the composition. According to an embodiment, the disintegrating agent is present in an amount of 0.1% to 20% w/w of the composition. According to an embodiment, the disintegrating agent is present in an amount of 0.1% to 10% w/w of the composition.

According to an embodiment, the binding agents or binders which are used in the pesticidal composition, but not limited to one or more of polyvinylalcohol, lactose, polyvinylyrrolidone, water soluble cellulose derivatives such as carboxymethyl cellulose, methyl cellulose, Starch, dextrins, lignin sulphonates and bentonite, carbohydrates such as monosaccharides, disaccharides, oligosaccharides and polysaccharides, clays, kaolins, attapulgite, xanthan gum, guar gum, Carrageenan, poly acrylates, poly carboxylates, carbomers, derivatives and combinations thereof. However, those skilled in the art will appreciate that it is possible to utilize different binding agents without departing from the scope of the present invention. The binding agents are commercially manufactured and available through various companies.

According to an embodiment, the binding agent is present in an amount of 0.1% to 50% w/w of the composition. According to further embodiment, the binding agent is present in an amount of 0.1% to 30% w/w of the composition. According to further embodiment, the binding agent is present in an amount of 0.1% to 20% w/w of the composition. According to further embodiment, the binding agent is present in an amount of 0.1% to 10% w/w of the composition.

According to an embodiment, the carriers which are used in the pesticidal composition include, but are not limited to one or more of solid carriers or fillers or diluents. According to another embodiment, the carriers include mineral carriers, plant carriers, synthetic carriers, water-soluble carriers. However, those skilled in the art will appreciate that it is possible to utilize different carriers without departing from the scope of the present invention. The carriers are commercially manufactured and available through various companies.

The solid carriers include natural minerals like clay such as bentonite, china clay, acid clay, dolomite, kaolin such as kaolinite, dickite, nacrite, and halloysite, synthetic and diatomaceous silicas, montmorillonite minerals such as sodium montmorillonite, smectites, such as saponite, hectorite, sauconite, and hyderite, micas, such as pyrophyllite, talc, agalmatolite, muscovite, phengite, sericite, and illite, silicas such as cristobalite, attapulgite, sepiolite; vermiculite, laponite, pumice, perlite, volclay, vermiculites, limestone, natural and synthetic silicates, charcoal, silica, powdered silica, fused silica, hydrophobic silica, wet process silicas, dry process silicas, calcined products of wet process silicas, surface-modified silicas, mica, zeolite, diatomaceous earth, derivatives thereof; fly ash, chalks (Omya®), fuller's earth, loess, mirabilite, white carbon, slaked lime, synthetic silicic acid, starch, modified starch (Pineflow, available from Matsutani Chemical industry co, Ltd.), sucrose, potassium pyrophosphate, sodium tripolyphosphate, kaolin 1777, Lactose, maltodextrin, dextrin, sorbitol; salts of lignin sulphonates such as ammonium, sodium, calcium, zinc. Water insoluble carriers include, but not limited to clays, microcrystalline cellulose, perlite, volcanic ash, mica, calcium or magnesium carbonates, diatomaceous earth, soap stone, starch, hydrophobically or hydrophilically modified starch, calcium phosphates. Water soluble salts such as, citrate, nitrate, sulphate, hexametaphosphate, phosphate, Ammonium salts such as sulphate, phosphate, magnesium sulphate. However, those skilled in the art will appreciate that it is possible to utilize different solid carriers without departing from the scope of the present invention. The solid carriers are commercially manufactured and available through various companies.

According to an embodiment, the carrier is present in an amount of 0.1% to 98% w/w of the composition. According to further embodiment, the carrier is present in an amount of 0.1% to 80% w/w of the composition. According to further embodiment, the carrier is present in an amount of 0.1% to 60% w/w of the composition. According to further embodiment, the carrier is present in an amount of 0.1% to 40% w/w of the composition. According to further embodiment, the carrier is present in an amount of 0.1% to 20% w/w of the composition.

According to an embodiment, the anticaking agents which are used in the pesticidal composition include, but are not limited to one or more of precipitated Silica, fumed silica, hydrophobically modified silica, Perlite, Mica, Talc, soapstone, Magnesium Aluminum silicate, clays, Calcium silicate, sodium bicarbonate, Magnesium trisilicate, fumed silica (white carbon), ester gum, a petroleum resin, Foammaster® Soap L sodium stearate, sodium metasilicate, sodium carbonate, Sodium alumino silicates, calcium carbonate and magnesium carbonate, Magnesium stearate, calcium phosphate salts or derivatives thereof. However, those skilled in the art will appreciate that it is possible to utilize different anti caking agents without departing from the scope of the present invention. The anti-caking agents are commercially manufactured and available through various companies.

According to an embodiment, the antifoaming agents or defoamers which are used in the pesticidal composition include, but not limited to one or more of silica, siloxane, silicone dioxide, polydimethyl siloxane and its derivatives, vegetable oils, petroleum oils, paraffin oil, polyethylene glycol, Silicone oils and magnesium stearate or derivatives thereof. Preferred antifoaming agents include silicone emulsions (such as, e.g., Silikon® SRE, Wacker or Rhodorsil® from Rhodia), long-chain alcohols, fatty acids. Non silicone defoamers can also be used. However, those skilled in the art will appreciate that it is possible to utilize other conventionally known antifoaming agents without departing from the scope of the present invention. The antifoaming agents are commercially manufactured and available through various companies.

According to an embodiment, the anti-foaming agent is present in an amount of 0.01% to 5% w/w of the total composition. According to an embodiment, the anti-foaming agent is present in an amount of 0.01% to 4% w/w of the total composition. According to an embodiment, the anti-foaming agent is present in an amount of 0.01% to 2% w/w of the total composition.

According to an embodiment, the pH-adjusters or buffers or neutralizing agents which are used in the pesticidal composition include both acids and bases of the organic or inorganic type and mixtures thereof. According to further embodiment, pH-adjusters or buffers or neutralizing agents include, but not limited to one or more of organic acids, inorganic acids and alkali metal compounds or salts, derivatives thereof. According to an embodiment, the organic acids include, but not limited to one or more of acetic, propionic, citric, oxalic, malic, adipic, fumaric, maleic, succinic, tartaric acid, hydrochloric acid, nitric acid, sulphuric acid, phosphoric acid, boric acid, phytic acid or salts, derivatives thereof; and the mono-, di-, or tribasic salts of these acids or derivatives thereof. Alkali metal compounds include, but not limited to one or more of hydroxides of alkali metals such as sodium hydroxide and potassium hydroxide, carbonates of alkali metals such as sodium carbonate, hydrogencarbonates of alkali metals such as sodium hydrogencarbonate and alkali metal phosphates such as sodium phosphate, sodium dihydrogen phosphate; sodium hydroxide, potassium hydroxide, ammonium hydroxide, Borax, sodium borate; calcium carbonate, calcium hydroxide, ferrous hydroxide, Magnesia, Lime, potassium acetate, potassium bicarbonate, potassium carbonate, sodium acetate, sodium benzoate, sodium carbonate, sodium bicarbonate, sodium metasilicate, trisodium phosphate, ammonia, primary amines, secondary amines and tertiary amines and mixtures thereof. According to an embodiment, the salts of organic acids include, but not limited to one or more of alkali metal salts such as sodium citrate and the like. Mixtures can also be used to create a pH-adjusters or buffers or neutralizing agents. However, those skilled in the art will appreciate that it is possible to utilize other conventionally known pH-adjusters or buffers or neutralizing agents without departing from the scope of the present invention. The pH-adjusters or buffers or neutralizing agents are commercially manufactured and available through various companies.

According to an embodiment, the pH-adjusters or buffers are present in an amount of 0.01% to 20% w/w of the total composition. According to an embodiment, the pH-adjusters or buffers are present in an amount of 0.01% to 10% w/w of the total composition. According to an embodiment, the pH-adjusters or buffers are present in an amount of 0.01% to 5% w/w of the total composition. According to an embodiment, the pH-adjusters or buffers are present in an amount of 0.01% to 1% w/w of the total composition.

According to an embodiment, the spreading agents which are used in the pesticidal composition include, but not limited to one or more of silicone surfactants, copolymer of maleic acid with a styrene compound, a (meth)acrylic acid copolymer, a half ester of a polymer consisting of polyhydric alcohol with dicarboxylic anhydride, a water-soluble salt of polystyrenesulfonic acid, fatty acids, aliphatic alcohols, vegetable oils such as cottonseed, or inorganic oils, petroleum distillates, modified trisiloxanes, polyglycol, polyethers, polyoxyalkylated ethyl phenols, polyoxyethoxylated fatty alcohols, polyoxyethoxylated fatty amines, alkylpolyglycol ether sulfonates, alkyl ether phosphates, Alkyl polyglucoside, Alkyl polysaccharide, vegetable oil, mineral oils, petroleum oils, silicone oils, siloxanes, polyoxyalkylene alkyl ethers, polyoxyalkylene alkylphenyl ethers, polyoxyalkylene polyhydric alcohol fatty acid esters, polyhydric alcohol fatty acid esters, polyoxyalkylene alkylamines, alkyl polyglycosides and glycidyl ethers are preferable. Examples of polyhydric alcohols constituting a nonionic surfactant include divalent alcohols such as ethyleneglycol, 1,2-propyleneglycol, 1,3-propyleneglycol, 1,4-butanediol, 2,3-butanediol, 1,5-pentanediol, 1,6-hexanediol, 1,8-octanediol, neopentyl glycol or 2-methyl-1,3-propanediol, trivalent alcohols such as glycerol, clathrates or salts or derivatives thereof. However, those skilled in the art will appreciate that it is possible to utilize other conventionally known spreading agents without departing from the scope of the present invention. The spreading agents are commercially manufactured and available through various companies.

According to an embodiment, the spreading agent is present in an amount of 0.1% to 20% w/w of the total composition. According to an embodiment, the spreading agent is present in an amount of 0.1% to 10% w/w of the total composition. According to an embodiment, the spreading agent is present in an amount of 0.1% to 5% w/w of the total composition. According to an embodiment, the spreading agent is present in an amount of 0.1% to 1% w/w of the total composition.

According to an embodiment, the sticking agents which are used in the pesticidal composition include, but not limited to one or more of, silicone-based surfactants, mineral oils, vegetable oils, petroleum oil, silicone oils, emulsifiers, fish oil or fatty acid soaps or emulsified vegetable oil. Carboxymethylcellulose and natural and synthetic polymers such as gum arabic, xanthan gum, guar gum, carrageenan, carbomer, polyvinyl alcohol, polyvinyl pyrrolidone and polyvinyl acetate, lecithins, carboxymethyl cellulose, natural and synthetic polymers, paraffin, a polyamide resin, polyacrylate, polyoxyethylene, wax, polyvinyl alkyl ether, an alkylphenol-formalin condensate, fatty acids, aliphatic alcohols, vegetable oils such as cottonseed, or inorganic oils, petroleum distillates, modified trisiloxanes, polyglycol, polyethers, clathrates, a synthetic resin emulsion or salts or derivatives thereof. However, those skilled in the art will appreciate that it is possible to utilize other conventionally known sticking agents without departing from the scope of the present invention. The sticking agents are commercially manufactured and available through various companies.

According to an embodiment, the sticking agent can be present in an amount of 0.1% to 5% w/w of the total composition. According to an embodiment, the sticking agent is present in an amount of 0.1% to 4% w/w of the total composition. According to an embodiment, the sticking agent is present in an amount of 0.1% to 3% w/w of the total composition.

According to an embodiment, the stabilizers which are used in the pesticidal composition include, but not limited to alkyl glyoxylates such as ethyl glyoxylate, zeolite, EDTA and chelating agents, sequestering agents, antioxidants such as sodium bisulphite, sodium metabisulphite, ascorbic acid, citric acid, malic acid and their salts; phenol compounds, and the like; ultraviolet absorbers such as benzophenone compounds or derivatives thereof. However, those skilled in the art will appreciate that it is possible to utilize other conventionally known stabilizers without departing from the scope of the present invention. The stabilizers are commercially manufactured and available through various companies.

According to an embodiment, the stabilizer is present in an amount of 0.1% to 30% w/w of the total composition. According to an embodiment, the stabilizer is present in an amount of 0.1% to 20% w/w of the total composition. According to an embodiment, the stabilizer is present in an amount of 0.1% to 10% w/w of the total composition.

According to an embodiment, the preservatives which are used in the pesticidal composition include but not limited to, one or more of bactericides, anti-fungal agents, biocides, anti-microbial agents, and antioxidant. Non limiting examples of preservatives include one or more of paraben, its esters and salts, propionic acid and its salts, 2,4-hexadienoic acid (sorbic acid) and its salt, formaldehyde and paraformaldehyde, 2-hydroxybiphenyl ether and its salts, inorganic sulfites and bisulfites, sodium iodate, chlorobutanol, 1,6-bis(4-amidino-2-bromophenoxy)-n-hexane and its salts, 5-amino-1,3-bis(2-ethylhexyl)-5-methylhexahydropyrimidine, 5-bromo-5-nitro-1,3-dioxane, 2-bromo-2-nitropropane-1,3-diol, 2,4-dichlorobenzyl alcohol, 5-chloro-2-(2,4-dichlorobenzylalcohol), N-(4-chlorophenyl)-N′-(3,4-dichlorophenyl) urea, 4-chloro-m-cresol, 2,4,4′-trichloro-2′-hydroxy diphenyl ether, 4-chloro-3,5-dimethyl phenol, 1,1′-methylene-bis(3-(1-hydroxy methyl-2,4-dioximidazolidin-5-yl)urea), 2-phenoxyethanol, hexamethylenetetramine, 1-(3-chloroallyl)-3,5,7-triaza-1-azonia-adamantane chloride, 1(4-chlorophenoxy)-1-(1H-imidazol-1-yl)-3,3-dimethyl-2-butanone, 1,3-bis(hydroxymethyl)-5,5-dimethyl-2,4-imidazolidinedione, benzyl alcohol, octopirox, 1,2-dibromo-2,4-dicyanobutane, 2,2′-methylenebis(6-bromo-4-chlorophenol), bromochlorophene, dichlorophene, 2-benzyl-4-chlorophenol, 2-chloroacetamide, chlorhexidine, chlorhexidine acetate, chlorhexidine gluconate, chlorhexidine hydrochloride, 1-phenoxypropan-2-ol, N-alkyl(C12-C22)trimethylammonium bromide and chloride, 4,4-dimethyl-1,3-oxazolidine, N-hydroxymethyl-N-(1,3-di(hydroxymethyl)-2,5-dioxoimidazolidin-4-yl)-N′-hydroxymethylurea, 1,6-bis(4-amidinophenoxy)-n-hexane and its salts, glutaraldehyde, 5-ethyl-1-aza-3,7-dioxabicyclo(3.3.0)octane, 3-(4-chlorophenoxy)propane-1,2-diol, Hyamine, alkyl(C8-C18)dimethylbenzyl ammonium chloride, alkyl(C8-C18)dimethylbenzylammonium bromide, alkyl(C8-C18)dimethylbenzylammonium saccharinate, benzyl hemiformal, 3-iodo-2-propynyl butylcarbamate, sodium hydroxymethylaminoacetate, cetyltrimethylammonium bromide, acetic acid, cetylpyridinium chloride, and derivatives of 2H isothiazol-3-one (so-called isothiazolone derivatives) such as alkylisothiazolones (for example 2-methyl-2H-isothiazol-3-one, MIT; chloro-2-methyl-2H-isothiazol-3-one, CIT), benzoisothiazolones (for example 1,2-benzoisothiazol-3(2H)-one, BIT, commercially available as Proxel® types from ICI) or 2-methyl-4,5-trimethylene-2H-isothiazol-3-one (MTIT), C1-C4-alkyl para-hydroxybenzoate, an dichlorophene, Proxel® from ICI or Acticide® RS from Thor Chemie and Kathon® MK from Rohm & Haas, Bacto-100, Sodium Propinoate, Sodium Benzoate, Propyl Paraben,Propyl Paraben Sodum, Potassium Sorbate, Potassium Benzoate, Phenyl Etehyl Alcohol, Sodium, Ethylparaben, Methylparaben, Butylparaben, Bezyla Alcohol, Benzothonium Chloride, Cetylpyridinium Chloride, Benzalkonium Chloride, 1,2-benzothiazol-3-one, Preventol® (Lanxess®), Butylhydroxytoluene, potassium sorbate, iodine-containing organic compounds such as 3-bromo-2,3-diiodo-2-propenyl ethyl carbonate, 3-iodo-2-propynyl butyl carbamate, 2,3,3-triiodo allyl alcohol, and parachlorophenyl-3-iodopropargylformal; benzimidazole compounds and benzthiazole compounds such as 2-(4-thiazolyl)benzimidazole and 2-thiocyanomethylthiobenzo-thiazole; triazole compounds such as 1-(2-(2′,4′-dichlorophenyl)-1,3-dioxolane-2-ylmethyl)-1H-1,2,4-triazole, 1-(2-(2′,4′-dichloro phenyl)-4-propyl-1,3-dioxolane-2-ylmethyl)-1H-1,2,4-triazole, and α-(2-(4-chlorophenyl)ethyl)-α-(1,1-dimethyl ethyl)-1H-1,2,4-triazole-1-ethanol; and naturally occurring compounds such as 4-isopropyl tropolone (hinokitiol) and borax or salts or derivatives thereof. Antioxidants includes but not limited to one or more of sodium or potassium bisulphites, sulphites, ascorbic acid, isoascorbic acid, imidazole and imidazole derivatives (e.g. urocanic acid), 4,4′-thiobis-6-t-butyl-3-methylphenol, 2,6-di-t-butyl-p-cresol (BHT), and pentaerythrityltetrakis[3-(3,5,-di-t-butyl-4-hydroxyphenyl)]propionate; amine antioxidants such as N,N′-di-2-naphthyl-p-phenylenediamine; hydroquinoline antioxidants such as 2,5-di(t-amyl)hydroquinoline; phosphorus-containing antioxidants such as triphenyl phosphatepropylthiouracil, hydroquinone and derivatives thereof (e.g. arbutin), ubiquinone and ubiquinol, and derivatives thereof, ascorbyl palmitate, stearate, di-palmitate, acetate, Mg ascorbyl phosphates, diso-diumascorbyl phosphate and sulfate, potassium ascorbyltocopheryl phosphate, isoascorbic acid and derivatives thereof, disodium rutinyldisulfate, dibutylhydroxytoluene, 4,4-thiobis-6-tert-butyl-3-methylphenol, butylhydroxy anisole, p-octylphenol, mono-(di- or tri-)methyl benzylphenol, 2,6-tert-butyl-4-methylphenol, pentaerythritol-tetrakis 3-(3,5-di-tert-butyl-4-hydroxyphenyl)propionate, butyl hydroxyl anisol, trihydroxy butyrophenone, thereof. However, those skilled in the art will appreciate that it is possible to utilize other conventionally known preservatives without departing from the scope of the present invention. The preservatives are commercially manufactured and available through various companies.

According to an embodiment, the preservative or bactericides or anti-fungal agents or biocides or anti-microbial agents or antioxidant is present in an amount of 0.1% to 5% w/w of the total composition. According to further embodiment, the preservative or bactericides or anti-fungal agents or biocides or anti-microbial agents or antioxidant is present in an amount of 0.1% to 4% w/w of the total composition. According to further embodiment, the preservative or bactericides or anti-fungal agents or biocides or anti-microbial agents or antioxidant is present in an amount of 0.1% to 3% w/w of the total composition. According to further embodiment, the preservative or bactericides or anti-fungal agents or biocides or anti-microbial agents or antioxidant is present in an amount of 0.1% to 1% w/w of the total composition.

According to an embodiment, the structuring agents which are used in the pesticidal composition include, but not limited to one or more of thickeners, viscosity modifiers, tackifiers, suspension aids, rheological modifiers or anti-settling agents. A structuring agent prevents sedimentation of the active ingredient particles after prolonged storage.

According to an embodiment, the structuring agents which are used in the composition include, but not limited to one or more polymers such as polyacrylics, polyacrylamides, polysaccharides, modified cellulose derivatives, co-polymers of cellulose derivatives, carboxyvinyl or polyvinyl pyrrolidones, polyethylenes, polyethylene oxide, polyvinyl alcohol and derivatives; clays such as bentonite clays, kaolin, smectite, attapulgites, attaclays, veegum, vangel with high surface area, silica and natural gums such as guar gum, xanthan gum, gum Arabic, gum tragacanth, rhamsan gum, locust bean gum, carrageenan, welan gum, dextrin, polyacrylic acids and their sodium salts; fumed silica, mixture of fumed silica and fumed aluminium oxide, swellable polymers, swelling clay, polyamides or its derivatives; polyols such as poly(vinyl acetate), sodium polyacrylate, poly(ethylene glycol), stachyose, fructo-oligosaccharides, amylose, pectins, alginates, hydrocolloids and mixtures thereof. Also, celluloses such as, carboxymethylcellulose, ethylcellulose, hydroxyethylcellulose, hydroxy-methyl ethyl cellulose, hydroxyl ethyl propyl cellulose, methylhydroxyethylcellulose, methylcellulose; starches, starch acetates, starch hydroxyethyl ethers, ionic starches, long-chain alkyl starches, dextrins, maltodextrin, corn starch, amine starches, phosphates starches, and dialdehyde starches; plant starches such as corn starch and potato starch; other carbohydrates such as pectin, amylopectin, xylan, glycogen, agar, gluten, alginic acid, phycocolloids, chitosan or derivatives thereof. However, those skilled in the art will appreciate that it is possible to utilize other conventionally known structuring agents without departing from the scope of the present invention.

Preferred structuring agents include one or more of xanthan gum, aluminum silicate, methylcellulose, polysaccharide, alkaline earth metal silicate, veegum, bentonite, attapulgite, kaolin and polyvinyl alcohol. The structuring agents are commercially manufactured and available through various companies.

According to an embodiment, the structuring agent is present in an amount of 0.01% to 5% w/w of the composition. According to an embodiment, the structuring agent is present in an amount of 0.01% to 4% w/w of the composition. According to an embodiment, the structuring agent is present in an amount of 0.01% to 3% w/w of the composition. According to an embodiment, the structuring agent is present in an amount of 0.01% to 2% w/w of the composition. According to an embodiment, the structuring agent is present in an amount of 0.01% to 1% w/w of the composition. According to an embodiment, the structuring agent is present in an amount of 0.01% to 0.1% w/w of the composition.

According to an embodiment, the antifreezing agents or freezing point depressants used in the liquid suspension composition include, but are not limited to one or more of polyhydric alcohols such as ethylene glycol, diethylene glycol, dipropylene glycol, propylene glycol, glycerol, monohydric or polyhydric alcohols, glycol ethers, glycol ethers, glycol monoethers such as the methyl, ethyl, propyl and butyl ether of ethylene glycol, diethylene glycol, propylene glycol and dipropylene glycol, glycol diethers such as methyl and ethyl diethers of ethylene glycol, diethylene glycol and dipropyleneglycol.or urea, glycerol, isopropanol, propylene glycol monomethyl ether, di- or tripropylene glycol monomethyl ether or carbohydrates such as glucose, mannose, fructose, galactose, sucrose, lactose, maltose, xylose, arabinose, sorbitol, mannitol, trehalose, raffinose or derivatives thereof. However, those skilled in the art will appreciate that it is possible to utilize different antifreezing agents without departing from the scope of the present invention. The antifreezing agents are commercially manufactured and available through various companies.

According to an embodiment, the chelating or complexing or sequestering agents which are used in the pesticidal composition include, but not limited to one or more of lignosulphonates, polycarboxylic acids such as polyacrylic acid and the various hydrolyzed poly(methyl vinyl ether/maleic anhydride); N-hydroxyethyliminodiacetic acid, nitrilotriacetic acid (NTA), N,N,N′,N′-ethylenediaminetetraacetic acid, N-hydroxyethyl-N, N′,N′-ethylenediaminetriacetic acid and N,N,N′,N″,N″-diethylenetriaminepentaacetic acid; α-hydroxy acids, such as citric acid, tartaric acid and gluconic acid; orthophosphates, such as trisodium phosphate, disodium phosphate, monosodium phosphate; condensed phosphates, such as sodium tripolyphosphate, tetrasodium pyrophosphate, sodium hexametaphosphate and sodium tetrapolyphosphate; 5-sulfo-8-hydroxyquinoline; and 3,5-disulfopyrocatechol, polycarboxylates, ethylene diamine tetraacetic acid (EDTA), diethylenetriaminepentaacetic acid (DTPA), N-hydroxyethyl-ethylenediamine-triacetic acid (HEDTA), ethylenediaminediacetate (EDDA), ethylenediaminedi(o-hydroxyphenylacetic) acid (EDDHA), cyclohexane diamine tetraacetic acid (CDTA), polyethyleneaminepolyacetic acids, lignosulfonate, Ca-, K-, Na-, and ammonium lignosulfonates, fulvic acid, ulmic acid, citric acids, cyclodextrin, phytic acid, humic acid, pyrophosphate. However, those skilled in the art will appreciate that it is possible to utilize other chelating or complexing or sesquitering agents without departing from the scope of the present invention. The chelating or complexing or sesquitering agents are commercially manufactured and available through various companies.

According to an embodiment, the penetrant which is used in the pesticidal composition include, but not limited to one or more of alcohol, glycol, glycol ether, ester, amine, alkanolamine, amine oxide, quaternary ammonium compound, triglyceride, polyoxyethylenetrimethylolpropane hexaoleate, sorbitan monooleate, polyoxyethylene sorbitan monolaurate, polyoxyethylene trimethylolpropane trioleate, ethoxylated triglycerides, ethoxylated polyol esters, alkoxylated alkanols and also alkoxylated triglycerides fatty acid ester, fatty acid ether, N-methyl pyrrolidone, dimethylformamide, dimethylacetamide, or dimethyl sulfoxide, polyoxyethylene trimethylol propane monooleate, polyoxyethylene trimethylol propanedioleate, polyoxyethylene trimethylol propanetrioleate, polyoxyethylene sorbitan monooleate, polyoxyethylene sorbitol hexaoleate. However, those skilled in the art will appreciate that it is possible to utilize different penetrants without departing from the scope of the present invention. The penetrants are commercially manufactured and available through various companies.

According to an embodiment, the ultraviolet absorbent is selected from, but not limited to one or more of zinc oxide, titanium oxide, lignosulphonates, 2-(2′-hydroxy-5′-methylphenyl)benzotriazole, 2-ethoxy-2′-ethyloxazalic acid bisanilide, succinic acid dimethyl-1-(2-hydroxyethyl)-4-hydroxy-2,2,6,6-tetramethylpiperidine polycondensate, benzotriazole compounds such as 2-(2′-hydroxy-5′-methylphenyl)benzotriazole and 2-(2′-hydroxy-4′-n-octoxyphenyl)benzotriazole; benzophenone compounds such as 2-hydroxy-4-methoxybenzophenone and 2-hydroxy-4-n-octoxybenzophenone; salicylic acid compounds such as phenyl salicylate and p-t-butylphenyl salicylate; 2-ethylhexyl 2-cyano-3,3-diphenyl acrylate, 2-ethoxy-2′-ethyl oxalic bisanilide, and dimethyl succinate-1-(2-hydroxyethyl)-4-hydroxy-2,2,6,6-tetramethylpiperidine polycondensate or derivatives or the like. However, those skilled in the art will appreciate that it is possible to utilize different ultraviolet absorbents, without departing from the scope of the present invention. Such ultraviolet absorbents are commercially manufactured and available through various companies.

According to an embodiment, the UV ray scattering agents include, but not limited to zinc oxide, titanium dioxide or the like may be used. However, those skilled in the art will appreciate that it is possible to utilize different UV ray scattering agents or mixtures thereof without departing from the scope of the present invention. Such UV ray scattering agents are commercially manufactured and available through various companies.

According to an embodiment, the polymeric shell wall material is a polyuria, polyurethane, aminoplast or polyisocyanate shell wall. However, those skilled in the art will appreciate that it is possible to utilize different material without departing from the scope of the present invention.

According to an embodiment, the humectant is selected from, but not limited to one or more of polyoxyethylene/polyoxypropylene copolymers, particularly block copolymers, such as the Synperonic PE series of copolymers available from Uniqema or salts, derivatives thereof. Other humectants are propylene glycol, monoethylene glycol, hexylene glycol, butylene glycol, ethylene glycol, diethylene glycol, poly(ethylene glycol), poly(propylene glycol), glycerol and the like; polyhydric alcohol compounds such as propylene glycol ether, derivatives thereof. Also other humectants include calcium chloride, sodium lactate, urea, polydextrose, sodium metaphosphate, amino acids such as proline; triacetin, etc. The non-ionic surfactants mentioned above also act as humectants. However, those skilled in the art will appreciate that it is possible to utilize other conventionally known humectants without departing from the scope of the present invention. The humectants are commercially manufactured and available through various companies.

According to an embodiment, the humectant is present in the range of 0.1% to 20% w/w of the total composition. According to an embodiment, the humectant is present in the range of 0.1% to 10% w/w of the total composition. According to an embodiment, the humectant is present in the range of 0.1% to 5% w/w of the total composition. According to an embodiment, the humectant is present in the range of 0.1% to 3% w/w of the total composition. According to an embodiment, the humectant is present in the range of 0.1% to 1% w/w of the total composition.

According to an embodiment, the ZC compositions or the water dispersible granules of capsulated suspension include monomers which include at least one first monomer employed in the organic phase which include isocyanates such as polymethylenepolyphenyleneisocyanate (PMPPI), hexamethylenediisocyanate (HMDI), isophoronediisocyanate (IPDI) or 4,4′ methylenebis(cyclohexyl isocyanate) and/or trimers of HMDI or IPDI and the like, isomers of toluene diisocyanate, isomers and derivatives of phenylene diisocyanate, isomers and derivatives of biphenylene diisocyanates, methylene diphenyl diisocyanate (MDI), polymeric polyisocyanates, biurets and blocked polyisocyanates or mixtures thereof.

The concentration of the isocyanate(s) and the ratio where more than one isocyanate is used, is chosen so as to obtain the desired release rate profile for the particular application. In general, the isocyanate(s) will comprise from about 0.1 to about 8%, more suitably from about 0.5 to about 6%, even more suitably from about 1% to about 5% and most suitably from about 0.5% to about 4%, by weight of the microcapsule.

According to an embodiment, the ZC compositions or the water dispersible granules of capsulated suspension includes at least one second monomer such as diamines or polyamines or mixtures thereof. The monomers include compounds which are soluble in the aqueous phase. Aliphatic or alicyclic primary or secondary diamines or polyamines such as ethylene-1,2-diamine, diethylenetriamine, triethylenetetramine, bis-(3-aminopropyl)-amine, bis-(2-methylaminoethyl)-methylamine, 1,4-diaminocyclohexane, 3-amino-1-methylaminopropane, N-methyl-bis-(3-aminopropyl)amine, 1,4-diamino-n-butane, propylene 1,3-diamine, tetramethylene diamine, pentamethylene diamine, 1,6-hexamethylene diamine, triethylene diamine, 1,6-diamino-n-hexane and tetraethylenepentamine and mixtures thereof are suitably used. Polyethyleneimines are also suitable. Diamines and polyamines, usually selected as water soluble per se or in-water soluble salt form, are polymethylene diamines, phenylene diamine, toluene diamine and piperazine.

Particularly suitable amines are polyfunctional amines which have a functionality greater than 2 but less than 3 and which may provide a degree of cross-linking in the shell wall. The polyfunctional amines should be in a water-soluble salt form. Suitable examples of polyfunctional amines which may be used include 1,3,5-benzene triamine trihydrochloride, 2,4,6-triamino toluene trihydrochloride, 1,3,6-triaminonaphthalene, 3,4,5-triamino-1,2,4-triazole, melamine, 2,4,5,8-tetramino anthraquinone, propylenediamine, isopropylenediamine, ethenediamine, triethylenetetraamine, bix-hexamethylenetriamine, polyalkylene polyamines such as pentaethylene hexamine, and the like. The amines may be used alone or in combination with each other, preferably in combination with 1,6-hexamethylenediamine (HMDA).

According to an embodiment, the ZC compositions or the water dispersible granules of capsulated suspension include protective colloids selected from at least one of polyvinyl alcohols, polyvinyl acetals, polyvinyl pyrrolidones, water-soluble polysaccharides such starches (amylose and amylopectin), celluloses and their methyl, hydroxyethyl and hydroxypropyl derivatives, and poly(meth)acryls. Polyvinyl alcohol is usually sold in a solid form with wide variations in molecular weight and degree of hydrolysis. The polyvinyl alcohol is added in an amount sufficient to enhance the stability of the microcapsules. Particularly, polyvinyl alcohol of lower molecular weight or lesser degree of hydrolysis, which are more water-soluble, are preferred.

According to an embodiment, the ZC compositions or the water dispersible granules of capsulated suspension include polymers such as polyurea formed by reaction of a polyisocyanate with a polyamine; polymers formed from melamine formaldehyde or urea formaldehyde condensates as well as similar types of aminoplasts, polyurethane, polyamide, polyolefin, polysaccharides, proteins, silica, lipid modified cellulose, gums, polyacrylates, polyphosphates, polystyrenes, polyesters or mixtures thereof.

According to an embodiment, the pesticidal composition can include at least one further active ingredient. According to an embodiment, the active ingredient can include at least one pesticidal active, nutrients selected from macronutrients, micro nutrients, bio stimulants, fertilizer, plant growth regulators, microbes, algae, bactereospores and mixtures thereof. However, those skilled in the art will appreciate that it is possible to utilize other further active ingredient without departing from the scope of the present invention.

According to an embodiment, the pesticidal actives include one or more of an antifoulant, an insecticide, a fungicide, a herbicide, a nematicide, a pheromone, a defoliant, an acaricide, a plant growth regulator, an algicide, an antifeedant, an avicide, a bactericide, a bird repellent, a biopesticide, a biocide, a chemosterilant, a safener, an insect attractant, an insect repellent, an insect growth regulator, a mammal repellent, a mating disrupter, a disinfectant, a molluscicide, an antimicrobial, a miticide, an ovicide, a fumigant, a plant activator, a rodenticide, a synergist, a virucide, a microbial pesticide, a plant incorporated protectant, other miscellaneous pesticidal actives or salts or derivatives and mixtures thereof, etc. However, those skilled in the art will appreciate that it is possible to utilize other pesticidal active without departing from the scope of the present invention.

According to further embodiment, the further active ingredient can be present in the concentration range of 0.1% w/w to 90% w/w of the total composition. According to further embodiment, the active ingredient can be present in the concentration range of 0.1% w/w to 70% w/w of the total composition. According to further embodiment, the active ingredient can be present in the concentration range of 0.1% w/w to 50% w/w of the total composition. According to further embodiment, the active ingredient can be present in the concentration range of 0.1% w/w to 30% w/w of the total composition.

It has been surprisingly found that the pesticidal composition of the present invention has enhanced and improved physical properties of dispersibility, suspensibility, wettability, viscosity, pourability, provides ease of handling and also reduces the loss of material while handling the product at the time of packaging as well as during field application.

According to an embodiment, viscosity of the liquid composition is determined as per CIPAC MT-192. According to an embodiment, the pesticidal composition has a viscosity at 250 C. of about 10 cps to about 3000 cps. According to an embodiment, the pesticidal composition has a viscosity at 25° C. of about 10 cps to about 2500 cps. According to an embodiment, the pesticidal composition has a viscosity at 25° C. of about 10 cps to about 2000 cps. According to an embodiment, the pesticidal composition has a viscosity at 25° C. of about 10 cps to about 1500 cps. According to an embodiment, the pesticidal composition has a viscosity at 250 C. of about 10 cps to about 1200 cps. According to an embodiment, the pesticidal composition has viscosity at 250 C. of about 10 cps to about 500 cps. According to an embodiment, the pesticidal composition has a viscosity at 250 C. of about less than 500 cps. According to an embodiment, the pesticidal composition has viscosity at 250 C. of about 10 cps to about 400 cps. According to an embodiment, the pesticidal composition has viscosity at 250 C. of about 10 cps to about 300 cps.

According to an embodiment, the liquid suspension composition of the present invention is easily pourable. The pourability is the measure of percent of residue.

According to an embodiment, the pourability of the pesticidal composition is determined as per CIPAC MT-148.1. According to a further embodiment, the pourability of the pesticidal composition is less than 5% residue. According to further embodiment, the pourability of the pesticidal composition is preferably less than 2.5% residue. According to further embodiment, the pourability of the pesticidal composition is more preferably less than 2.0% residue.

According to an embodiment, the pesticidal composition has a dispersibility of at least 30%. According to an embodiment, the pesticidal composition has a dispersibility of at least 40%. According to an embodiment, the pesticidal composition has a dispersibility of at least 50%. According to an embodiment, the pesticidal composition has a dispersibility of at least 60%. According to an embodiment, the pesticidal composition has a dispersibility of at least 70%. According to an embodiment, the pesticidal composition has a dispersibility of at least 80%. According to an embodiment, the pesticidal composition has a dispersibility of at least 90%. According to an embodiment, the pesticidal composition has a dispersibility of at least 99%. According to an embodiment, the pesticidal composition has a dispersibility of 100%. Dispersibility of the composition of the present application, was determined as per the standard CIPAC test, MT 174.

Suspensibility is defined as the amount of active ingredient suspended after a given time in a column of liquid, of stated height, expressed as a percentage of the amount of active ingredient in the original suspension. The test for suspensibility is done as per the CIPAC Handbook, “MT 184 Test for Suspensibility”.

According to an embodiment, the pesticidal composition has a suspensibility of at least 30%. According to an embodiment, the pesticidal composition has suspensibility of at least 40%. According to an embodiment, the pesticidal composition has a suspensibility of at least 50%. According to an embodiment, the pesticidal composition has a suspensibility of at least 60%. According to an embodiment, the pesticidal composition has a suspensibility of at least 70%. According to an embodiment, the pesticidal composition has a suspensibility of at least 80%. According to an embodiment, the pesticidal composition has a suspensibility of at least 90%. According to an embodiment, the pesticidal composition has a suspensibility of at least 99%. According to an embodiment, the pesticidal composition has a suspensibility of 100%.

According to an embodiment, the pesticidal composition demonstrates superior stability in terms of suspensibility under accelerated storage condition (ATS). According to an embodiment, the pesticidal composition demonstrates suspensibility of at least 90% under ATS. According to an embodiment, the pesticidal composition demonstrates suspensibility of at least 80% under ATS. According to an embodiment, the pesticidal composition demonstrates suspensibility of at least 70% under ATS. According to an embodiment, the pesticidal composition demonstrates suspensibility of at least 60% under ATS. According to an embodiment, the pesticidal composition demonstrates suspensibility of at least 50% under ATS. According to an embodiment, the pesticidal composition demonstrates suspensibility of at least 40% under ATS. According to an embodiment, the pesticidal composition demonstrates suspensibility of at least 30% under ATS.

According to an embodiment, the pesticidal composition demonstrates dispersibility of at least 90% under ATS. According to an embodiment, the pesticidal composition demonstrates dispersibility of at least 80% under ATS. According to an embodiment, the pesticidal composition demonstrates dispersibility of at least 70% under ATS. According to an embodiment, the pesticidal composition demonstrates dispersibility of at least 60% under ATS. According to an embodiment, the pesticidal composition demonstrates dispersibility of at least 50% under ATS. According to an embodiment, the pesticidal composition demonstrates dispersibility of at least 40% under ATS. According to an embodiment, the pesticidal composition demonstrates dispersibility of at least 30% under ATS.

Wettability is the condition or the state of being wettable and can be defined as the degree to which a solid is wetted by a liquid, measured by the force of adhesion between the solid and liquid phases. The wettability of the granular composition is measured using the Standard CIPAC Test MT-53 which describes a procedure for the determination of the time of complete wetting of wettable formulations. A weighed amount of the granular composition is dropped on water in a beaker from a specified height and the time for complete wetting was determined. According to another embodiment, the pesticidal composition in the form of water dispersible granules, spheronised granule or broadcast granules or water disintegrable granule has wettability of less than 2 minutes. According to another embodiment, the wettability of less than 1 minute. According to another embodiment, the pesticidal composition has wettability of less than 30 seconds.

According to an embodiment, the pesticidal composition demonstrates superior stability towards heat, light, temperature and caking. According to an embodiment, the stability exhibited by the pesticidal composition is at least 3 years. According to further embodiment, the stability exhibited by the pesticidal composition is at least 2 years. According to further embodiment, the stability exhibited by the pesticidal composition is at least 1 year. According to further embodiment, the stability exhibited by the pesticidal composition is at least 6 months.

According to an embodiment, the present invention relates to a process of preparing the pesticidal composition of the present invention comprising Elemental Sulphur present in the range of 20% w/w to 90% w/w of the total composition and Acynonapyr present in the range of 0.01% w/w to 50% w/w of the total composition and at least one agrochemically acceptable excipient.

According to another embodiment, the pesticidal composition in the form of water dispersible granules or spheronised granules or water disintegrable granule or broadcast granule, is made by various techniques such as spray drying, fluidized bed granulation, pan granulation, pin agglomerator, spheronizer, freeze drying etc. The granules can also be extruded through the extruder to obtain extruded granules.

According to an embodiment, the process of preparing a water dispersible granular pesticidal composition involves milling a blend of Elemental Sulphur, Acynonapyr and at least one excipient to obtain slurry or a wet mix. The process of preparing a water dispersible granular pesticidal composition, according to an embodiment, particularly involves milling a blend of Elemental Sulphur, Acynonapyr followed by addition of at least one filler or carrier and at least one excipient to obtain slurry or a wet mix with particle size of 0.1 micron to 50 microns. The wet mix obtained is then dried, for instance in a spray dryer followed by sieving to remove the undersized and oversized granules to obtain water dispersible granules of the desired size if required. However, those skilled in the art will appreciate that it is possible to modify or alter or change the process or process parameters to obtain water dispersible granular composition without departing from the scope of the present invention. Furthermore, water is added to the dry powder and the mixture is blended to obtain a wet mass, which is then extruded through an extruder to obtain the granules of desired size. The granules can also be formed with hot melt extrusion. However, those skilled in the art will appreciate that it is possible to modify or alter or change the process or process parameters to obtain granular composition without departing from the scope of the present invention.

The granules obtained from the extruder can also be dried in open air or air-dried or using a suitable dryer, to remove any residual moisture, if any. However, those skilled in the art will appreciate that it is possible to modify or alter or change the process or process parameters without departing from the scope of the present invention.

According to another embodiment, the invention further relates to the process for preparing the water disintegrable granule or broadcast granule or spheronised granule which involves milling a blend of Elemental Sulphur, Acynonapyr and at least one excipient to obtain slurry or a wet mix. The process particularly involves milling a blend of Elemental Sulphur, Acynonapyr and at least one agrochemically acceptable excipient to obtain a milled powder mix. This milled powder mix is then granulated with water in which a suitable binder may be added. On reaching the desired consistency, the wet mass is extruded using a suitable extruder or optionally spheronized to obtain spherical granules. The spherical granules are then dried in a tray dryer or in a fluid bed dryer to obtain water disintegrable granules. The dried granules are then sieved to remove the undersized and oversized granules to obtain granules of uniform granule size. The powder or the fine granules are further subjected to agglomeration in an agglomerator to obtain granules of size of about 0.1 mm to 6 mm. According to an embodiment the composition comprises at least one filler or carrier during the process of preparation of making the composition. The agglomerator can include various equipment's such as a disc pelletizer or pan granulator, pin agglomerator, extruder, spheronizer, or combinations thereof.

According to an embodiment, the invention relates to a process for preparing wettable powder composition. The process comprises mixing Acynonapyr with excipients to form a dry mass using a mass mixer. Further adding Elemental Sulphur and other ingredients to the mixture and passing the mixture through a jet mill to obtain powder with desired particle size.

According to an embodiment, the invention relates to a process for preparation of the liquid suspension pesticidal composition, the process comprising: homogenizing mixture of Elemental Sulphur, Acynonapyr and at least one agrochemically acceptable excipient to obtain a suspension and wet milling the obtained suspension to provide the liquid suspension composition. However those skilled in the art will appreciate that it is possible to modify or alter or change the process or process parameters without departing from the scope of the present invention.

According to an embodiment, the gel composition of the present invention is prepared by adding more amounts of viscosity modifiers to the suspension concentrate or liquid suspension composition. However, those skilled in the art will appreciate that it is possible to modify or alter or change the process or process parameters to obtain gel composition without departing from the scope of the present invention.

According to an embodiment, the ZC composition of the present invention is prepared by mixing suspension concentrate of Elemental Sulphur and capsulated suspension of Acynonapyr. The process for preparing suspension concentrate of Elemental Sulphur comprises adding suitable excipients to water and Elemental Sulphur is suspended in it to form a slurry. The slurry is milled using a suitable wet mill to obtain the desired particle size. Separately, the process for preparing a capsulated suspension of Acynonapyr comprises dissolving Acynonapyr in a suitable oil, adding a polymer precursor to the oil and emulsifying the oil in water using a suitable homogenizer. A crosslinker for the polymer precursor is added in the water phase either alone or optionally along with at least one excipient. The capsulated suspension is then added to Elemental Sulphur suspension under continuous stirring. Further, at least one excipient is added at this stage and the mixture is then spray dried to obtain a dry ZC formulation. Alternately, if a ZC formulation is desired, the spray drying step can be avoided and at least one humectant, biocide and structuring agent can be added to the mixture of suspension concentrate and capsulated suspension.

According to an embodiment, the invention relates to a process for preparation of a suspoemulsion pesticidal composition, the process comprising dissolving Acynonapyr in an oil or a solvent and preparing a concentrated emulsion with required agrochemical excipients to obtain a first fraction. The process further comprises mixing effective amount of Elemental Sulphur with surfactants or excipient to obtain a second fraction which is then milled to get the desired particle size. The two fractions obtained are then mixed using a suitable homogenizer for 30 minutes to obtain the suspoemulsion composition with the desired particle size of 0.1 to 50 microns.

According to an embodiment, the invention further relates to a method of application of the composition.

According to an embodiment, the invention also relates to a method of protecting the crop, controlling plant pathogen, controlling pest, improving the crop health and growth, enhancing the crop yield, strengthening the plant, the method comprising treating at least one of a plant, crop, plant propagation material, locus or parts thereof, a seed, seedling or surrounding soil with the pesticidal composition which includes Elemental Sulphur present in the range of 20% w/w to 90% w/w of the total composition and Acynonapyr present in the range of 0.1% w/w to 50% w/w of the total composition. The composition may be sprayed directly to the plant, such as its foliage or applied to the plant propagation material, before it is sown or planted, or to the locus thereof.

The composition is applied through a variety of methods. Methods of applying to the soil include any suitable method, which ensures that the composition penetrates the soil, for example nursery tray application, in furrow application, soil drenching, soil injection, drip irrigation, sprinkler irrigation, seed treatment, seed painting and such other methods. The composition is particularly applied in the form of a foliar spray.

The rates of application or the dosage of the composition depends on the type of use, the type of crops, or the specific active ingredients in the composition such that the pesticidal active ingredient, is in an effective amount to provide the desired action (such as crop protection, crop yield).

According to an embodiment, the composition of the present invention is synergistic in nature and provides good control on plant pathogens such as insect pest as compared to application of individual actives. Further such composition helps in improving the crop yield, crop characteristics etc. Thus, it has been observed that the compositions of the present invention, demonstrate enhanced, efficacious and superior behavior in the fields at reduced dosage.

### A. Preparation Examples

The following examples illustrate the basic methodology and versatility of the composition of the invention. It should be noted that this invention is not limited to these exemplifications and can be extrapolated to overall claimed concentration range of the components.

### Example 1: Water Dispersible Granular Formulation of 88% Elemental Sulphur and 2% Acynonapyr

Water dispersible granular composition was prepared by adding 88 parts of Elemental Sulphur, 2 parts of Acynonapyr along with 1 part of Naphthalene sulphonate condensate, 5 parts of Tensiofix LX and 4 parts of Stepsperse 500 to 100 parts of water. The powder was mixed with water in a suitable mixing equipment to form a slurry or wet mix.

The slurry obtained was wet ground in suitable wet grinding equipment. The wet milled slurry obtained was spray dried at an inlet temperature less than 140° C. and outlet temperature less than 90° C. to get a granular powder. The composition had the particle size of about 15 microns and granule size of 2 mm. The composition had a dispersibility of 84%, suspensibility of 65%, wet sieve retention value of 0.25% and wettability of less than 20 sec. The composition further demonstrated suspensibility of about 60% and dispersibility of about 78% under accelerated storage condition.

### Example 2: Water Dispersible Granule of 60% Elemental Sulphur and 6% of Acynonapyr

The granules are prepared as per process described in example 1 by blending 60 parts of Elemental Sulphur, 6 parts of Acynonapyr, 10 parts of Supragil MNS 90, 5 parts of Supragil WP, 15 parts of ligninsulphonate, and 4 parts of kaolin. The composition had the particle size of about 8 microns and granule size of 1.5 mm. The composition has a dispersibility of 87%, suspensibility of 73%, wettability of less than 12 sec and wet sieve retention 0.2%. The composition further demonstrated dispersibility of 75% and suspensibility of about 80% under accelerated storage condition.

### Example 3: Water Dispersible Granule of Elemental Sulphur 50% and 35% of Acynonapyr

The granules are prepared by extrusion as per the following process: Mix Sulphur 50 parts and Acynonapyr 35 parts in a mass mixer. Add 2 parts of Geropon T36, 1 parts of Geropon T77, 8 parts of Ufoxane 3A, 2 parts of silica, 2 of china clay and mix well to obtain a uniform dry mix. The dry mix was milled using a suitable mill to get a particle size of 21.4 microns. This milled powder was granulated using water to obtain a wet mass with the desired consistency. It was extruded to obtain extruded granules. The wet extruded granules were dried using a suitable dryer to obtain granule with a size of about 2.5 to 5.0 mm. The composition has a dispersibility of 96%, suspensibility of 78%, wettability of less than 25 sec and wet sieve retention 0.12%. The composition further demonstrated dispersibility of 90% and suspensibility of about 71% under accelerated storage condition.

### Example 4: Water Dispersible Granules of 45% Elemental Sulphur and 25% of Acynonapyr

The granules are prepared as per process described in example 3 by blending 45 parts of Elemental Sulphur, 25 parts of Acynonapyr, 8 parts of Oparyl DT, 14 parts of Tersperse 2700, 3 parts of soapstone and 5 parts of silica. The composition had the particle size of about 18 microns and granule size of 2.1 mm. The composition has a dispersibility of 90%, suspensibility of 82%, wettability of less than 30 sec and wet sieve retention 0.12%. The composition further demonstrated dispersibility of 85% and suspensibility of about 75% under accelerated storage condition.

### Example 5: Liquid Suspension Composition of 45% Elemental Sulphur and 10% Acynonapyr

Liquid suspension composition was prepared by mixing 45 part of Elemental Sulphur, 10 part of Acynonapyr, 5 parts of monoethylene glycol, 2.5 parts of Morwet D425, 0.5 parts of Soprophor 3D33, 0.5 parts of potassium sorbate and 36.35 parts of water and homogenised by feeding them into a vessel provided with stirring facilities until the total mixture was homogeneous. Subsequently, the suspension obtained was passed through the wet mill to obtain a suspension with 4 microns particle size. Then, 0.15 part of xanthan gum was added under continuous homogenization to obtain the suspension concentrate. The composition has suspensibility of about 92%, dispersibility of 90%, wet sieve retention of 0.1%, viscosity of about 600 cps, pourability of less than 1.5. The composition has suspensibility of about 89%, dispersibility of 90% and viscosity of about 650 cps under accelerated storage condition.

### Example 6: Liquid Suspension Composition of 40% Elemental Sulphur and 5% Acynonapyr

Liquid suspension prepared as per example 5 and comprises 40 parts of Elemental Sulphur, 5 parts of Acynonapyr, 3 parts of soprophor 3D33, 2 part of Morwet D425, 5 parts of propylene Glycol, 0.1 part of Benzisothiazolinone, 0.2 part of xanthan gum, 0.2 parts of silicone antifoam and 44.5 parts of water. The composition has particle size of about 4 microns, suspensibility of about 95%, dispersibility of 85%, viscosity of about 620 cps, and pourability of less than 1.7%, wet sieve retention of 0.08%. The composition has suspensibility of about 90%, dispersibility of 80% and viscosity of about 750 cps under accelerated storage condition.

### Example 7: Liquid Suspension Composition of 25% Elemental Sulphur and 20% Acynonapyr

Liquid suspension prepared as per example 5 and comprises 25 parts of Elemental Sulphur, 20 parts of Acynonapyr, 4 parts of Reax 907M, 1.5 part Geropon SC 213, 5 parts of polyethylene glycol 400, 0.1 part of Rocima BT 2S,0.2 parts of silicone antifoam, 0.2 part of xanthan gum and 44 parts of water. The composition has particle size of about 6 micron, suspensibility of about 70, dispersibility of 75%, viscosity of about 800 cps, and pourability of less than 2%, wet sieve retention of 0.18%. The composition has suspensibility of about 65%, dispersibility of 71% and viscosity of about 820 cps under accelerated storage condition.

### Example 8: Wettable Powder of 90% Elemental Sulphur and 5% Acynonapyr

Wettable powder is prepared by mixing 90 parts of Elemental Sulphur, 5 parts of Acynonapyr, 1.5 part of sodium dodecyl sulphate, 0.45 parts of precipitated silica and 2.1 parts of clay. The obtained mixture is passed through jet mill to get particles with size of about 7.5 microns with suspensibility of 77% wettability of 15 seconds, dispersibility of 80%. The composition has suspensibility of about 72%, dispersibility of 75% under accelerated storage condition.

### Example 9: Water Dispersible Granules of Capsulated Suspension Composition or ZC of 25% of Elemental Sulphur and 1% of Acynonapyr

The suspension concentrate of Elemental Sulphur was prepared by mixing 25 parts of Elemental Sulphur with 3 parts of polycarboxylate sodium and 2 parts of Morwet D425 with water. The slurry is then milled using a suitable wet mill to obtain the desired particle size. The capsulated suspension is prepared by dissolving 1.5 parts of Polyvinyl alcohol (PVA) in water. 1 part of Acynonapyr technical is dissolved in 5 parts of Garosol 110 and 1.5 parts of Polymethylene diisocyanate is added to the oil. The oil phase is added to the PVA solution while being homogenized to form an emulsion. 0.5 parts of Ethyelenediamine is added followed by 0.2 parts of citric acid, 0.05 parts of Potassium hydroxide and 0.19 parts of antifoam.

The Elemental Sulphur suspension concentrate is mixed with Acnonapyr Capsulated suspension to form a ZC. 5 parts of Propylene glycol, 0.1 parts of Benzisothiazolinone and 0.11 parts of xanthan gum are added under stirring to ZC or combination of Elemental Sulphur suspension concentrate and Acnonapyr Capsulated suspension. The formulation had a particle size of 6.2 microns and a suspensibility of 92% and a viscosity of 790 cps. The formulation showed a suspensibility of 88% and a viscosity of 810 cps under accelerated storage condition.

### Example 10: Water Dispersible Granules of Capsulated Suspension of 40% of Elemental Sulphur and 0.1% of Acynonapyr

The suspension concentrate of Elemental Sulphur and capsulated suspension of Acynonapyr was prepared as per example 9. The two were mixed together and to the mixture 10 parts of Borresperse NA, 9 parts of Ammonium sulphate, 0.3 parts of silicone antifoam and 23.6 parts of maltodextrin were added. The slurry was then spray dried to obtain a dry capsulated suspension. The composition had a particle size of 8.3 microns, a suspensibility of 75% and a dispersibility of 80%. The formulation showed a suspensibility of 72% and a dispersibility of 76% under accelerated storage conditions.

### Example 11: Water Disintegrable Granular Composition of 30% Sulphur and 20% Acynonapyr

The composition was prepared by blending 30 part of Elemental Sulphur and 20 part of Acynonapyr, 4 parts of Morwet D500, 50.93 parts of Borresperse CA, 3 parts of precipitated silica and 9.07 parts of talc to obtain a blend, 4 part of polyvinylpyrrolidone and 24 parts of maltodextrin. The blend obtained was milled to get a powder of less than 50-micron particle size. The powder was granulated with water to obtain a wet mass suitable for extrusion. The wet mass was extruded using a suitable extruding equipment and then spheronized to get spherical granules measuring approximately 4.5 mm. The spheronized granules were dried in a fluidized bed dryer for 30 minutes at 45 degrees C.

The sample had a granule size of 4.5 mm, particle size of 30 micron. The granular composition had wettability of less than 100 second, suspensibility of 50% and dispersibility of 47%. The composition further demonstrated dispersibility of 41% and suspensibility of about 46% under accelerated storage condition.

### Example 12: Water Disintegrable Granular Composition of 80% Elemental Sulphur and 10% Acynonapyr

The spheronised granules are prepared as per example 11 which comprises 80 parts of Elemental Sulphur technical, 10 parts of Acynonapyr, 5 parts of Ligninsulphonate sodium and 3 parts of ammonium sulphate and 2 parts of bentonite. The sample had a granule size of 3.5 mm, particle size of 22 micron. The granular composition had wettability of less than 80 second, suspensibility of 55% and dispersibility of 50%. The composition further demonstrated dispersibility of 44% and suspensibility of about 50% under accelerated storage condition.

### Example 13: ZC Composition of 20% Elemental Sulphur and 10% Acynonapyr

Firstly Sulphur slurry was prepared by taking sufficient quantity of water (quantity sufficient) in a beaker and adding the surfactants such as 5 parts of Soprophor 3D33, 5 parts of monoethylene glycol and 2 parts of Resicare MSW. 20 parts of Sulphur was then added and milled to get the desired particle size. To obtain the Acynonapyr capsulated suspension 10 parts of Acynonapyr and 5 parts of Solvesso 200ND was mixed. Further a solution of 1.5 parts of Kuraray Poval 3-98 was prepared in water. 1.5 parts of Polymethylene diisocyanate was added to the oil phase and added dropwise to the Kuraray Poval 3-98 solution in water at 50 degrees C. Further 1.25 parts of Trimethylol propane was dissolved in water and added to the dispersion. Thereafter, the milled suspension of Sulphur and Acynonapyr CS in 1:1 w/w ratio was mixed. 0.12 parts of xanthan gum and 0.1 part of Benzisothiazolinone were then added under stirring. The resulting ZC composition had a Sulphur content of 20% and Acynonapyr content of 10%.

The composition has particles with size of about 18 microns with suspensibility of 89%. The composition has suspensibility of about 78%, under accelerated storage condition.

### Example 14: Suspoemulsion Composition of 35% Elemental Sulphur and 5% Acynonapyr

The suspoemulsion was prepared by adding 3.5 parts of alcohol ethoxylate followed by 2 parts of Powerblox SN, 2 parts of Stepac TSPK, 0.1 part of Benzisothiazolinone and 5 parts of propylene glycol to a sufficient quantity of water in a beaker. To this mixture 35 parts of Elemental Sulphur was added. The slurry obtained was blended using a lab homogenizer for 30 minutes and milled using a bead mill to get the desired particle size. Separately 5 parts of Acynonapyr and 10 parts of Garasol 110 and 1 part of diocotyl sulfosuccinate sodium was added. The oil phase was added to the aqueous Sulphur suspension while stirring using a homogenizer. 0.1 parts of Xanthan gum was added to the mixture to get the desired viscosity. The composition has particle size of about 7 microns, suspensibility of about 85, viscosity of about 390 cps, and pourability of less than 1%, wet sieve retention of 0.01%. The composition has suspensibility of about 82%, and viscosity of about 410 cps under accelerated storage condition.

### B. Field Studies

Field trial 1: To study effect of Elemental Sulphur and Acynonapyr for controlling Red Spider Mites (RSM) in Tea.

The field trials were carried out to study the effect of composition of Elemental Sulphur and Acynonapyr on Red Spider Mites in Tea crop. The trial was laid out with seven treatments including untreated control, replicated four times. The test product sample, Elemental Sulphur and Acynonapyr, alone and in combination with prescribed dose were applied as foliar. The Tea crop in trial field was raised following good agricultural practice.

### Details of Experiment

a) Trial Location: Siliguri, WB
b) Crop: Tea & TV 25
d) Trial Design: RBD
e) Replications: Four
I) Treatment: seven
g) Plot size:70 Sqm (7×10 m)
h) Date of Application
i) Method of application: Foliar
   Record count of RSM from 5 top leaves from each bush was observed. Randomly 3 bushes per replication at beginning of the trial were tagged and RSM population from those bushes throughout the observation period were recorded. The observations are to be recorded at pre-count, 1, 3, 5, 7, 10, 14 and 21 days after application and mean data is presented in Table 1.

Control (%)=[Damage in control plot−Damage in treated plot)/Damage in control plot]×100

TABLE 1

Active
ingredient
(grams/

| | | |
|---|---|---|
| Treatment | hectare) | RSM count mean value/9 Leaf of tea |

| No. | Composition | A | B | 1DAA | 3DAA | 5DAA | 7DAA | 14DAA | 21DAA |
|---|---|---|---|---|---|---|---|---|---|
| T1 | Sulphur 60% + | 1500 | 150 | 3.2 | 0.5 | 0.8 | 1.2 | 1.3 | 1.2 |
| | Acynonapyr 6% | | | | | | | | |
| | WDG @ 2500 | | | | | | | | |
| | gm/ha according to | | | | | | | | |
| | an embodiment of | | | | | | | | |
| | the present | | | | | | | | |
| | invention. | | | | | | | | |
| T2 | Sulphur 30% + | 1500 | 150 | 2.1 | 0.8 | 0.9 | 1.3 | 1.4 | 1.5 |
| | Acynonapyr 3% | | | | | | | | |
| | Extruded WDG @ | | | | | | | | |
| | 5000 gm/ha | | | | | | | | |
| | according to an | | | | | | | | |
| | embodiment of the | | | | | | | | |
| | present invention. | | | | | | | | |
| T3 | Sulphur 90% + | 1350 | 75 | 3.2 | 1.1 | 1.2 | 1.4 | 1.0 | 1.9 |
| | Acynonapyr 5% | | | | | | | | |
| | WP@ 1500 gm/ha | | | | | | | | |
| | according to an | | | | | | | | |
| | embodiment of the | | | | | | | | |
| | present invention. | | | | | | | | |
| T4 | Sulphur 80% | 1500 | | 3.5 | 4.6 | 6.5 | 6.8 | 8.3 | 10.2 |
| | WDG@1875 gm/ha | | | | | | | | |
| T5 | Acynonapyr 6% EC | | 150 | 3.1 | 3.3 | 2.7 | 4.5 | 6.4 | 8.4 |
| | @2500 gm/ha | | | | | | | | |
| T6 | Hexythiazox 5.45% | — | — | 4.2 | 3.5 | 7.3 | 8.1 | 10.1 | 9.5 |
| | EC @500 gm/ha | | | | | | | | |
| T7 | Untreated control | — | — | 3.5 | 10.2 | 13.4 | 15.3 | 14.5 | 17.8 |

| Treatment | % Control of RSM (Red Spider Mites) | | | | | |
|---|---|---|---|---|---|---|
| No. | 1DAA | 3DAA | 5DAA | 7DAA | 14DAA | 21DAA |
| T1 | 8.57* | 95.10* | 94.3* | 92.16* | 91.03* | 93.26* |
| T2 | 40* | 92.16* | 93.28* | 91.50* | 90.34* | 91.57* |
| T3 | 8.57* | 89.22* | 91.04* | 90.85* | 93.10* | 89.33* |
| T4 | 0 | 54.9 | 51.49 | 55.56 | 42.76 | 42.70 |
| T5 | 11.43 | 67.65 | 79.85 | 70.59 | 55.8 | 52.81 |
| T6 | −20 | 65.69 | 45.52 | 47.06 | 30.34 | 46.63 |
| T7 | | | | | | |

*Synergistic effect;
A = Sulphur;
B = Acynonapyr;
WP—Wettable Powder;
WDG—Water Dispersible Granule

It can be observed from the data presented in table 1 that composition comprising Elemental Sulphur and Acynonapyr as per embodiment of the present invention is synergistic in nature and effective in controlling Red Spider Mites(RSM) in Tea. The synergistic composition prepared as per embodiment of the present invention also has been effective in treating mites as compared to individual application of Elemental Sulphur, Acynonapyr, and commercially used pesticides for mites and untreated plot.

“Synergy” is as defined by Colby S. R. in an article entitled “Calculation of the synergistic and antagonistic responses of herbicide combinations” published in Weeds, 1967, 15, p. 20-22. The action expected for a given combination of two active components can be calculated as follows:

$$E = X + Y - ( XY / 100 )$$

Where,
E=Expected % effect by mixture of two products X and Y in a defined dose.
X=Observed % effect by product A
Y=Observed % effect by product B
The synergy factor (SF) is calculated by Abbott's formula (Eq.(2)(Abbott, 1925).
SF=Observed effect/Expected effect
Where, SF>1 for Synergistic reaction; SF<1 for antagonistic reaction; SF=1 for additive reaction.

When the percentage of yield or control effect observed (E) for the combination is greater than the expected percentage, synergistic effect of the combination can be inferred. When the percentage effect observed for the combination is equal to the expected percentage, merely an additive effect may be inferred, and wherein the percentage effect observed for the combination is lower than the expected percentage, an antagonistic effect of the combinations can be inferred.

For instance, on comparing treatment T1 (Sulphur 60%+Acynonapyr 6% WDG as per embodiment of the present invention), T2 (Sulphur 30%+Acynonapyr 3% WDG as per embodiment of the present invention) with T4 (Sulphur 80% WDG) and T5 (Acynonapyr 6% EC) applied at same dosage, it was noted that treatment T1 and T2 demonstrated control of 93.26% and 91.57% respectively whereas treatment T4 and T5 demonstrated 42.7% and 52.81% control against mites at 21 days after application. Furthermore it was observed that treatment T3 (Sulphur 90%+Acynonapyr 5% WP as per embodiment of the present invention) applied at reduced dosage demonstrated better control on mites as compared to treatment T3 and treatment T4.

Also, on comparing treatment T1, T2 and T3 with T6, it was noted that treatments T1, T2 and T3 depicted better control on mites as compared to treatment T5 (Hexythiazox 5.45% EC which is a commercial pesticides against mites). Thus, the combination of Elemental sulphur and Acynonapyr in the form of WDG and WP with particles in the size range of 0.1 micron to 50 microns as per embodiment of the present invention is synergistic in nature and provides better control on insect pest as compared to application of individual actives and commercial pesticides.

Field Trial 2: To study effect of composition comprising Elemental Sulphur and Acynonapyr on Chilli.

The field trial was carried out on a commercially cultivated Chilli field at Guntur, Andhra Pradesh to compare the efficacy of composition of Elemental Sulphur and Acynonapyr in Chilli. The trial was laid out during spring season in Randomized Block Design (RBD) with five treatments including untreated control. The compositions of the present invention with prescribed dose were applied as foliar spray.

The Chilli crop in trial field was raised following good agricultural practice.

### Details of Experiment

a) Trial Location: Guntur, Andhra Pradesh
b) Crop: Chilli (var Sitara green chilly)
c) Trial Design: Randomized Block Design
d) Pest: Red spider mites (RSM)
e) Treatment: Five
f) Plot size: 5 m×6 m=30 sq.m
g) Date of transplanting: 5.07.2021
h) Date of Application: 10.09.2021
i) Method of application: Foliar spray with hollow cone nozzle
j) Water volume used per ha: 500 L

The RSM population from chilli was recorded from 5 top terminal leaves wherein randomly 5 plants per replication were selected at beginning of the trial and mite were recorded throughout the observation period and mean data is as presented in Table 2:

| | | Active | | | | | | | |
|---|---|---|---|---|---|---|---|---|---|
| | | ingredient | | | | | | | |
| | | (grams/ | | | | | | | |
| Treatment | | hectare) | | RSM count mean value/9 Leaf of tea | | | | | |
| No. | Composition | A | B | 1DAA | 3DAA | 5DAA | 7DAA | 14DAA | 21DAA |
| T1 | Sulphur 40% + | 1200 | 150 | 2.5 | 1.7 | 0.9 | 1.1 | 1.7 | 1.5 |
| | Acynonapyr 5% SC | | | | | | | | |
| | @ 3000 gm/ha | | | | | | | | |
| | according to an | | | | | | | | |
| | embodiment of the | | | | | | | | |
| | present invention. | | | | | | | | |
| T2 | Sulphur 80% + | 1200 | 150 | 2.3 | 1.1 | 1.2 | 2.0 | 2.4 | 1.1 |
| | Acynonapyr 10% | | | | | | | | |
| | WDG @1500 gm/ha | | | | | | | | |
| | according to an | | | | | | | | |
| | embodiment of the | | | | | | | | |
| | present invention. | | | | | | | | |
| T3 | Sulphur 80% | 1200 | | 4.1 | 4.7 | 6 | 5.8 | 7.3 | 10.7 |
| | WDG@1500 gm/ha | | | | | | | | |
| T4 | Acynonapyr 6% EC | | 150 | 3.1 | 4.0 | 5 | 4.5 | 6.4 | 5.9 |
| | @ 2500 gm/ha | | | | | | | | |
| T5 | Untreated control | — | — | 5 | 10.2 | 15 | 12 | 15 | 19.5 |

| Treatment | % Control of RSM (Red Spider Mites) | | | | | |
|---|---|---|---|---|---|---|
| No. | 1DAA | 3DAA | 5DAA | 7DAA | 14DAA | 21DAA |
| T1 | 50* | 83.33* | 94.00* | 90.83* | 88.67* | 92.31* |
| T2 | 54* | 89.22* | 92.00* | 83.33* | 84* | 94.36* |
| T3 | 18 | 53.92 | 60 | 51.67 | 51.33 | 45.13 |
| T4 | 38.00 | 60.78 | 66.7 | 62.50 | 57.33 | 69.74 |
| T5 | | | | | | |

*Synergistic effect,
A = Sulphur;
B = Acynonapyr
SC—Suspension Concentrate or Liquid suspension
WDG—Water Dispersible Granule

| | | Number | Yield | | |
|---|---|---|---|---|---|
| | | of | (Total of 6 | | |
| Treatment | | fruits/ | pickings) | % Increase | Crop |
| No. | Composition | plant | (Kg/ha) | in Yield | phytotoxicity |
| T1 | Sulphur 40% + Acynonapyr 5% SC | 15 | 20500 | 24.24 | 0 |
| | @ 3000 gm/ha according to an | | | | |
| | embodiment of the present | | | | |
| | invention. | | | | |
| T2 | Sulphur 80% + Acynonapyr 10% | 18 | 21000 | 27.27 | 0 |
| | WDG @1500 gm/ha according to | | | | |
| | an embodiment of the present | | | | |
| | invention. | | | | |
| T3 | Sulphur 80% WDG@1500 gm/ha | 12 | 18500 | 12.12 | 0 |
| T4 | Acynonapyr 6% EC @ 2500 gm/ha | 9 | 17500 | 6.01 | 0 |
| T5 | Untreated control | 7 | 16500 | | 0 |

It can be observed from the data presented in table 2, that composition comprising Elemental Sulphur and Acynonapyr prepared as per embodiment of the present invention is synergistic in nature and effective in controlling mites in chilli. The percent of mites is found to be minimum in the plot treated with treatment T1 and T2 respectively as compared to other treatments which indicates that the composition of the present invention is superior in protecting chilli crop against mites. For instance, treatment T2 had 94% control after 21 days of application whereas treatments T3 and T4 depicted control of about 45% and 69.7% respectively. Furthermore, yield of chilli was found highest with treatment T1, T2 as compared to treatments T3, T4 and untreated plot. The percent increase in yield with treatment T1, T2 was about 24.24% and 27.27% respectively whereas with treatment T3 and T4 was about 12.12% and 6.01% respectively. Thus, it can be noted that the composition comprising of Elemental sulphur and Acynonapyr in various formulation types with particles in the size range of 0.1 micron to 50 microns as per embodiment of the present invention is synergistic in nature and provides better control on insect pest and higher crop yield as compared to application of individual actives.

Further, the inventors of the present invention also tested the composition of Elemental sulphur and Acynonapyr in various formulation types on crops such as tomato, okra, citrus brinjal etc. It was observed that the composition of the present invention provides enhanced control of pests as compared to application of individual actives. Further the composition of the invention also helped in improving the crop yield, crop physiological characteristics like root length, plant height, fruit size and improved foliage etc. Thus, it has been observed that the compositions of the present invention, demonstrate enhanced, efficacious and superior behavior in the fields.

The inventors have further determined that the present composition not only provides immediate but also continuous and sustained release of actives during the entire crop life cycle, when applied to the soil, thereby providing an effective crop protection and nutritive solution to the crops. This is on account of the composition having specific properties i.e. the composition when added to water disperses into particles of specific size range, with good suspensibility, dispersibility and wettability for granules or powders and with good viscosity and suspensibility for liquid compositions. composition of the present invention also provides immediate release of actives strengthening and protecting the crop against pest attack, when applied foliar or to the soil. Because of its ease of application, the composition is highly economical to the end user.

From the foregoing, it will be observed that numerous modifications and variations can be effectuated without departing from the true spirit and scope of the novel concepts of the present invention. It is to be understood that no limitation with respect to the specific embodiments illustrated is intended or should be inferred.

1.-19. (canceled)

20. A pesticidal composition, comprising:
elemental sulphur in a range of 20% w/w to 90% w/w of a total composition;
acynonapyr in a range of 0.1% w/w to 50% w/w of the total composition; and
at least one agrochemically acceptable excipient.

21. The pesticidal composition of claim 20, wherein the pesticidal composition comprises particles in a size range of 0.1 micron to 50 microns.

22. The pesticidal composition of claim 20, wherein the pesticidal composition is in a form of a solid or a form of a liquid or a form of a gel.

23. The pesticidal composition of claim 22, wherein the pesticidal composition in the form of the solid is in a form of: water dispersible granules or extruded granules, water disintegrable granules or broadcast granules or spheronised granules, wettable powder, water disintegrable granules of capsulated suspension.

24. The pesticidal composition of claim 23, wherein the water disintegrable granules or the broadcast granules or the extruded granules or the spheronised granules are in a size range of 0.1 mm to 6 mm.

25. The pesticidal composition of claim 23, wherein the water dispersible granules or the water dispersible granules of capsulated suspension are in a size range of 0.1 mm to 2.5 mm.

26. The pesticidal composition of claim 22, wherein the pesticidal composition in the form of the liquid is in a form of: flowable concentrate, liquid suspension, suspoemulsion, ZC composition; and wherein the ZC composition is a combination of capsulated suspension and suspension concentrate.

27. The pesticidal composition of claim 20, wherein the pesticidal composition further comprises at least one active ingredient selected from: macronutrients, micro nutrients, bio stimulant, fertilize, pesticidal actives, plant growth regulators, algae, bacteriospores, and mixtures thereof.

28. The pesticidal composition of claim 20, wherein the at least one agrochemically acceptable excipient is selected from at least one of: surfactants, binders or binding agents, wetting agent, emulsifiers, disintegrating agents, dispersing agent, fillers or carriers or diluents, buffers or pH adjusters or neutralizing agents, antifoaming agents or defoamers, penetrants, ultraviolet absorbents, UV ray scattering agents, stabilizers, pigments or colorants, structuring agents, chelating or complexing or sesquitering agents, thickeners, suspending agents or suspension aid agents or anticaking agents or anti-settling agents, viscosity modifiers or rheology modifiers, tackifiers, humectants, sticking agents, anti-freezing agent or freeze point depressants, polymers, monomers, cross-linking agents, permeability enhancing agents, protective colloids, solvents, and mixtures thereof.

29. The composition of claim 23, wherein suspensibility or dispersibility of the pesticidal composition is at least 30% under accelerated storage condition.

30. The composition of claim 29, wherein suspensibility or dispersibility of the pesticidal composition is at least 30% under accelerated storage condition.

31. A process for preparing the pesticidal composition of claim 20 in a form of a water dispersible granule, the process comprising:
a) milling a blend of the elemental sulphur and the acynonapyr with the at least one agrochemically acceptable excipient to obtain a slurry or a wet mix; and
b) drying the slurry or the wet mix to obtain the pesticidal composition in the form of the water dispersible granule;
wherein the water dispersible granule is in a size range of 0.1 mm to 2.5 mm.

32. A process for preparing the pesticidal composition of claim 20 in a form of a water disintegrable granule, the process comprising:
a) milling a blend of the elemental sulphur and the acynonapyr with the at least one agrochemical excipient to obtain a slurry or a wet mix;
b) drying the slurry or the wet mix to obtain a dry powder comprising the pesticidal composition in the form of the water disintegrable granule, wherein the water disintegrable granule is in a size range of 0.1 mm to 2.5 mm;
c) adding water to the dry powder and blending to obtain a dough or a paste; and
d) i) extruding the dough or the paste through an extruder to obtain extruded granules in a size range of 0.1 mm to 6 mm; or
ii) agglomerating the wet mix or the dry powder in an agglomerator to obtain the granules in the size range of 0.1 mm to 6 mm.

33. A process for preparing the pesticidal composition of claim 20 in a form of a ZC composition, the process comprising:
a) preparing a suspension concentrate of the elemental sulphur by adding the at least one agrochemically acceptable excipient to water, suspending the elemental sulphur in the water to form a slurry, and milling the slurry using a suitable wet mill to obtain a desired particle size;
b) preparing a capsulated suspension by dissolving the acynonapyr in a suitable oil, adding a polymer precursor to the suitable oil, and emulsifying the suitable oil in the water using a suitable homogenizer;
c) adding crosslinker for the polymer precursor to the water, optionally, with the at least one agrochemically acceptable excipient;
d) adding the capsulated suspension to the suspension concentrate of the elemental sulphur under continuous stirring to obtain the ZC composition; and
e) optionally, adding at least one humectant, biocide, and structuring agent to a mixture of the suspension concentrate of the elemental sulphur and the capsulated suspension.

34. A process for preparing the pesticidal composition of claim 20 in a form of a dry ZC formulation or a form of water dispersible granules of capsulated suspension, the process comprising:
a) preparing a suspension concentrate of the elemental sulphur by adding the at least one agrochemically acceptable excipient to water, suspending the elemental sulphur in the water to form a slurry, and milling the slurry using a suitable wet mill to obtain a desired particle size;
b) preparing a capsulated suspension by dissolving the acynonapyr in a suitable oil, adding a polymer precursor to the suitable oil, and emulsifying the suitable oil in the water using a suitable homogenizer;
c) adding crosslinker for the polymer precursor to the water, optionally, with the at least one agrochemically acceptable excipient;
d) adding the capsulated suspension to the suspension concentrate of the elemental sulphur under continuous stirring; and
e) adding the at least one agrochemically acceptable excipient and spray drying a mixture of the capsulated suspension and the suspension concentrate of the elemental sulphur the to obtain the dry ZC formulation or the water dispersible granules of capsulated suspension.

35. A process for preparing the pesticidal composition of claim 20 in a form of a suspoemulsion, the process comprising:
a) dissolving the acynonapyr in an oil or a solvent and preparing a concentrated emulsion with the at least one agrochemically acceptable excipient to obtain a first fraction;
b) mixing the elemental sulphur with the at least one agrochemically acceptable excipient to obtain a second fraction, and milling the second fraction to obtain a desired particle size; and
c) mixing the first fraction and the second fraction in a mass mixer for 30 minutes to obtain the pesticidal composition in the form of the suspoemulsion with the desired particle size.

26. A method for treating at least one of: a plant, crop, plant propagation material, locus, parts thereof or seed, seedling, or soil with the pesticidal composition of claim 20.
